(19) United States
(12) Patent Application Publication
(10) Pub. No.: US 2024/0267738 A1
(43) Pub. Date: Aug. 8, 2024

(54) METHOD AND APPARATUS FOR PRE-SHARED SYMMETRIC KEYS FOR OUT-OF-BAND TEMPORARY KEY SHARING AND BLUETOOTH PAIRING

(71) Applicant: Dell Products, LP, Round Rock, TX (US)

(72) Inventors: Anantha K. Boyapalle, Cedar Park, TX (US); Kai Leong Wong, Singapore (SG); Nicholas D. Grobelny, Evergreen, CO (US)

(73) Assignee: Dell Products, LP, Round Rock, TX (US)

(21) Appl. No.: 18/105,361

(22) Filed: Feb. 3, 2023

(51) Int. Cl. H04W 12/50; H04L 9/08

(52) U.S. Cl. CPC H04W 12/50; H04L 9/0819; H04L 9/0866

(57) ABSTRACT

An information handling system includes a hardware processor and a memory device to execute code instructions of an automatic peripheral device pairing management system pairing agent to receive, via a wireless interface adapter, a symmetric key to receive a symmetric key-wrapped secure pairing key data package from a wireless peripheral device as part of a pairing query. The hardware processor to, with the symmetric key, unwrap the symmetric key-wrapped secure pairing key data package to obtain pairing key data used to automatically Bluetooth® (BT) pair the backend coupled information handling system to the wireless peripheral device when the pairing key data matches peripheral device pairing key data at the wireless peripheral device including a received or generated out-of-band temporary key at the information handling system with a copy generated at the wireless peripheral device.

### FIELD OF THE DISCLOSURE

The present disclosure generally relates to Bluetooth pairing of a peripheral device with an information handling system. The present disclosure more specifically relates to automatic querying, verification, and pairing of a peripheral device with an information handling system using symmetric keys.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling needs and requirements vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. Still further, information handling systems may be operatively coupled to, via a pairing process, various peripheral devices that allow a user to interact with the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system and a wireless peripheral device (PD) including a peripheral device pairing management system pairing agent to be paired with the information handling system according to an embodiment of the present disclosure;

FIG. 2 is a graphic diagram of an information handling system pairable with one or more wireless peripheral devices and operably coupled to a wireless peripheral device manufacturer according to an embodiment of the present disclosure;

FIG. 3 is a process flow diagram of a method of automatically querying, verifying, and Bluetooth® pairing a wireless peripheral device to an information handling system using symmetrical keys and a symmetrical key wrapped pairing key data package from a wireless peripheral device according to an embodiment of the present disclosure; and

FIG. 4 is a process flow diagram of a method of automatically querying, verifying, and Bluetooth® pairing a wireless peripheral device to an information handling system using symmetrical keys and a symmetrical key wrapped pairing key data package from a wireless peripheral device manufacturer according to another embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Information handling systems operate to provide computing, data storage, and application resources among other computing resources. A plurality of peripheral devices may be operatively coupled, wirelessly, to the information handling system such as via a Bluetooth® (BT) wireless protocol. The wireless peripheral devices allow the user to interact with the information handling system by receiving output and proving input to the information handling system. Some peripheral devices may serve as both input and output devices. Although some peripheral devices may have a wired connection with the information handling system, wireless peripheral devices are operatively coupled to the information handling system via a radio of a wireless interface adapter in the information handling system and a radio located within the wireless peripheral devices, for example BT wireless systems. In order to allow for the operative coupling of a wireless peripheral device to the information handling system, the wireless peripheral device may initiate a pairing process. This pairing process, in order for the operative coupling to be secure, includes security protocols that securely couple the wireless peripheral device to the information handling system. This prevents the wireless peripheral device from being operatively coupled to or hacked from information handling systems that are not associated with the user. In some instances, this requires the user to input certain pairing credentials such as a unique number in order to pair the wireless peripheral device with the information handling system. Along with this pairing process requiring user input to initiate the pairing process (e.g., not being automatic), is not always entirely secure and could result in a third-party gaining control of the wireless peripheral device using another information handling system with leak of a code or intercept of the pairing exchange. Further, such a manual pairing process can be cumbersome for users.

The present specification describes an information handling system that includes a hardware processor, a memory device, and a power management unit (PMU) to provide power to the hardware processor and memory device. The information handling system may be available to pair with a wireless peripheral device (PD) via a touchless, automatic query, verification, and pairing system of embodiments herein. The hardware processor of the information handling system executes computer readable program code of an automatic peripheral device pairing management system pairing agent to receive, via a network interface adapter, a symmetric key from a backend management server or from another source such as a peripheral device manufacturer. This symmetric key matches a symmetric key stored on a memory device of a wireless peripheral device assigned to or otherwise to be paired with the information handling system.

The hardware processor the information handling system also executes computer readable program code instructions of the automatic peripheral device pairing management system to, via the network interface adapter, receive a symmetric key-wrapped secure pairing key data package from a wireless peripheral device. In an embodiment, the wireless peripheral device may, with a random number generator, create an out-of-band (OOB) temporary key to be used to verify both sides of the BT pairing. The wireless peripheral device uses a pairing key data encryption agent to create a symmetric key-wrapped secure pairing key data package used to securely provide the information handling system with a peripheral device identification (PD ID) and either with a copy of the OOB temporary key or seed and index data usable to generate the temporary key at the information handling systems. The PD ID and OOB temporary key are used to, with a peripheral device identification, automatically query, verify, and Bluetooth® (BT) pair the information handling system with the wireless peripheral device.

In an embodiment, the hardware processor of the information handling system executes computer readable program code of the automatic peripheral device pairing management system pairing agent to, with the symmetric key, unwrap the symmetric key-wrapped secure pairing key data package to obtain pairing key data used to BT pair the information handling system to the wireless peripheral device. As described, in one embodiment, this pairing key data may include a copy of the OOB temporary key and the PD ID. In another embodiment, the pairing key data may include a copy of the PD ID and a copy of seed and index data used to generate the OOB temporary key with a key generating algorithm at the information handling system to be in line with a copy generated and stored at the wireless PD.

Thus, in an embodiment, the symmetric key-wrapped secure pairing key data package may be a symmetrical key-wrapped OOB temporary key and PD ID data package. In an embodiment the hardware processor of the information handling system executes the computer readable program code of the automatic peripheral device pairing management system pairing agent to unwrap the symmetrical key wrapped OOB temporary key and PD ID using the copy of the symmetric key to obtain the pairing key data that includes the copy of the OOB temporary key and PD ID and store the OOB temporary key and PD ID in a memory. In an embodiment, a memory on the information handling system that may use used is a unified extensible firmware interface (UEFI) memory and a UEFI variable used for access by an operating system (OS) Bluetooth® (BT) stack for automatic verification and BT pairing with the wireless peripheral device.

In another embodiment, the symmetric key-wrapped secure pairing key data package may be a symmetrical key-wrapped seed and index data and PD ID data package. In an embodiment, the hardware processor of the information handling system executes the computer readable program code of the automatic peripheral device pairing management system pairing agent to unwrap the symmetrical key-wrapped seed and index data and PD ID package using the copy of the symmetric key to obtain the pairing key data that includes seed and index data. This seed and index data is used in a hash loop of a key generation algorithm executed by a hardware processor of the information handling system to generate the OOB temporary key and reveal the PD ID. Then the OOB temporary key and PD ID may be stored in memory. For example, it may be stored as a unified extensible firmware interface (UEFI) variable in UEFI memory for access by an operating system (OS) Bluetooth® (BT) stack for automatic verification and pairing with the wireless peripheral device.

In an embodiment, the information handling system does not BT pair with the wireless peripheral device without first comparing the PD ID between the information handling system and the wireless peripheral device to ascertain whether they match or not. Upon doing so, then determining a matched set of OOB temporary keys will allow BT pairing to proceed. In some other embodiments, the information handling system may request signal strength indicator (RSSI) level from a wireless peripheral device to determine if the RSSI level detected meets or exceeds a RSSI threshold level indicating that the wireless peripheral device is close enough to BT pair.

In an embodiment, the symmetric key-wrapped secure pairing key data package includes the OOB temporary key and PD ID encrypted with the symmetrical key, where the GOB temporary key is generated by the wireless peripheral device after the wireless peripheral device has been turned on and before the wireless peripheral device broadcasts the symmetrical key wrapped pairing key data package in a querying package to the information handling system. In one embodiment, a hardware controller of the peripheral device executes computer readable program code of a pairing key data encryption agent to encrypt an OOB temporary key and the PD ID with a copy of the symmetric key to create the symmetrical key-wrapped OOB temporary key and PD ID version of the symmetrical key wrapped pairing key data package, wherein the OOB temporary key is generated by the hardware controller of the peripheral device by executing a random number generator of a key generation algorithm. In another embodiment, a hardware controller of the peripheral device executes computer readable program code of a pairing key data encryption agent to encrypt a seed and index data and the PD ID with a copy of the symmetric key to create the symmetrical key-wrapped seed and index data and PD ID version of the symmetrical key wrapped pairing key data package, wherein the OOB temporary key is generated at the information handling system as well as by the hardware controller of the peripheral device where both may execute a random number generator of the same or similar key generation algorithms.

The pairing process may end with the information handling system and wireless peripheral device establishing a session key and establish a BT wireless link. In one embodiment, the hardware processor executing computer readable program code of the automatic peripheral device pairing management system pairing agent to delete OOB temporary keys derived or generated from the symmetric key-wrapped secure pairing key data package after the information handling system has been BT paired with the wireless peripheral device.

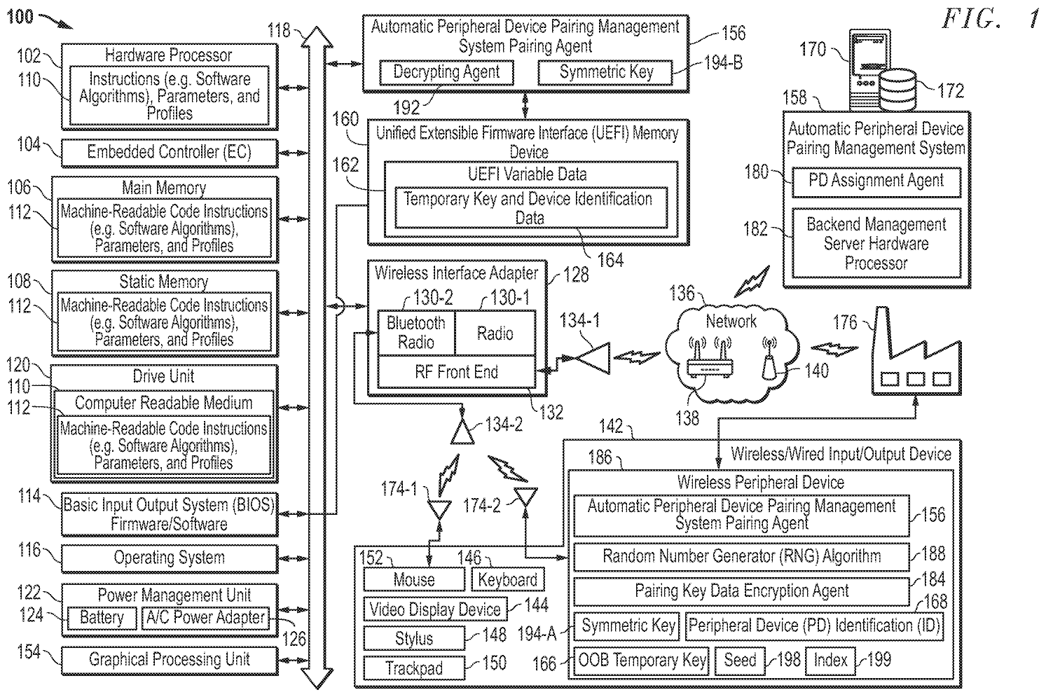

FIG. 1 illustrates an information handling system 100, similar to information handling systems according to several aspects of the present disclosure including an information handling system 100. It is contemplated that several of the hardware components and the aspects shown of the information handling system 100 may also apply to a backend management server 170, in some embodiments, which may assign a purchased wireless device 142 to an information handling system 100 in some embodiments and may distribute symmetric keys in an embodiment. For example, the backend management server 170 may execute code instructions of a PD assignment agent 180 via a hardware processor such as backend management server hardware processor 182 according to an embodiment. The backend management server 170 also executes code instructions of an automatic peripheral device pairing management system 158 via a hardware processor such as backend management server hardware processor 182 according to embodiments herein. In other embodiments, the backend management server may not be required and a manufacturer may provide symmetric keys to the information handling system 100 and store the same on the wireless peripheral device 186. The information handling system 100 executes, with a hardware processor 102, embedded controller 104, or other hardware processing resources, an automatic PD pairing management system pairing agent 156 that may interface with a backend management server 170 executing code instructions of the automatic peripheral device pairing management system 158 or with a manufacturer 176 in various embodiments described herein to facilitate, for example, an assignment of the peripheral device (PD) 142 to the information handling system 100. In the embodiments described herein, the information handling system 100 or other information handling systems described herein includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, the information handling system 100 or other information handling system described herein can be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a convertible laptop, a two-in-one computer, a tablet, a smartphone, a communications device, an access point (AP), a base station transceiver, a wireless telephone, a control system, a camera, a scanner, a printer, a personal trusted device, a web appliance, or any other suitable machine capable of executing a set of machine-readable code instructions (sequential or otherwise) that specify actions to be taken by that machine, and can vary in size, shape, performance, price, and functionality.

In a networked deployment, the information handling system 100 or the backend management server 170 may operate in the capacity of a server or as a client computer in a server-client network environment, or as a peer computer system in a peer-to-peer (or distributed) network environment. In a particular embodiment, the information handling system 100 or the backend management server 170 can be implemented using electronic devices that provide voice, video, or data communication. For example, an information handling system 100 or the backend management server 170 may be any mobile or other computing device capable of executing, via a hardware processing resource, a set of machine-readable code instructions (sequential or otherwise) that specify actions to be taken by that machine. In an embodiment, the information handling system 100 may be operatively coupled to a server such as the backend management server 170 or other network device as well as with any wireless peripheral devices 142. Further, while a single information handling system 100 is illustrated, the term “system” shall also be taken to include any collection of hardware systems or hardware sub-systems that individually or jointly utilize one or more hardware processing resources to execute a set, or multiple sets, of machine-readable code instructions to perform one or more computer functions.

The information handling system 100 may include memory (volatile (e.g., random-access memory, etc.), nonvolatile (read-only memory, flash memory etc.) or any combination thereof), one or more hardware processing resources, such as a hardware processor 102, a central processing unit (CPU), a graphics processing unit (GPU) 154, an embedded controller (EC) 104, other hardware processing device, hardware controller, or any combination thereof. Additional components of the information handling system 100 can include one or more storage devices, one or more communications ports for communicating with external devices, as well as various input and output (I/O) devices 142, such as a keyboard 146, a mouse 152, a video display device 144, a stylus 148, a trackpad 150, or any combination thereof. It is appreciated that the wireless peripheral device 186 shown in FIG. 1 can be any of the types of peripheral devices and/or wireless/wired input/output device 142 and the systems and methods described herein apply to any type of wireless peripheral device 186 described herein. The information handling system 100 can also include one or more buses 118 operable to transmit data communications between the various hardware components described herein. Portions of an information handling system 100 may themselves be considered information handling systems and some or all of which may be wireless. It is appreciated, as well, that the structure and hardware of the information handling system 100 described herein may also apply to the backend management server 170. For purposes of the present specification, the information handling system 100 is used to communicate with the backend management server 170 which, in some embodiments, directs that a symmetric key be sent to an information handling system 100 to which the wireless peripheral device 186 is assigned. It is appreciated, in some embodiments, that the assignment of the wireless peripheral device 186 to the information handling system 100 may be accomplished by a wireless peripheral device manufacturer 176 sending a symmetric key 194 to the information handling system 100 without the specific assignment by the backend management server 170. For purposes of the present specification, an information handling system 100 includes those information handling systems that receive a symmetric key 194-B to receive a PD ID 168 and to receive or generate OOB temporary key 166 used to query, verify, and Bluetooth® (BT) pair the wireless peripheral device 186 to the information handling system 100. The OOB temporary key 166 may be generated from seed 198 and index 199 data at the wireless peripheral device 186 as well as at the information handling systems 100 in some embodiments executing a random number generator (RNG) algorithm 188, also referred to as a key generating algorithm. Such a symmetric key 194 is also stored by wireless peripheral device manufacturer 176 on memory on the wireless peripheral device 186. As such, the wireless peripheral device manufacturer 176 may securely transmit the symmetric key 194 to the information handling system 100 to be used to securely share PD ID 168 and the OOB temporary key 166 or seed 198 and index 199 data to generate the same for automatic querying, verification, and BT pairing with a wireless peripheral device 186. In an embodiment, through the execution of computer readable program code of a random number generator algorithm 188 and the out-of-band (OOB) temporary key encryption agent 184, the information handling system 100 receives encrypted data of or for generating the OOB temporary key 166 and PD ID 168. The hardware processor 102 or embedded controller (EC) 104 may execute the automatic peripheral device pairing management system pairing agent 156 to compare the OOB temporary key 166 received or generated at the information handling system with same at the wireless peripheral device 186 via a confirm value generation function executed on both sides for Bluetooth® (BT) pairing verification. Although FIG. 1 shows a single information handling system 100, the present specification contemplates that multiple information handling systems 100 may each receive a symmetrical key 194-B that matches a symmetrical key 194-A stored on one or more wireless peripheral devices 142 to be paired with each of the specific information handling systems 100.

The information handling system 100 or the backend management server 170 can include devices or modules that embody one or more of the hardware devices or hardware processing resources to execute machine-readable code instructions for the one or more systems and modules described above and operates to perform one or more of the methods described herein. In an example, machine-readable code instructions may be executed by an EC, a CPU, the hardware processor 102, or other hardware processing resource such as an embedded controller (EC) 104 for the automatic peripheral device pairing management system pairing agent 156, of a decrypting agent 192, or a RNG algorithm 188, in some embodiments. Similarly, a hardware controller at wireless peripheral device 186 may execute code instructions of the automatic peripheral device pairing management system pairing agent 156, an RNG algorithm 188 and a pairing key data encryption agent 184 in embodiments herein. In another example, machine-readable code instructions may be executed by an EC, a CPU, backend management server hardware processor 182, or other hardware processing resource of a backend management server 170 for an automatic peripheral device pairing management system 158 or execute instructions of a peripheral device (PD) assignment agent 180 in an embodiment.

The information handling system 100 and wireless peripheral device 186 may each execute counterpart code instructions of the automatic peripheral device pairing management system pairing agent 156 to control the discovery, verification, and initialization of BT pairing of a wireless peripheral device 186 to an information handling system 100. A hardware processor 102, for example, at the information handling system 100 executing the automatic peripheral device pairing management system pairing agent 156 may conduct verification and pairing with an OS BT stack (not shown) and a decrypting agent 192 as described in embodiments herein. The information handling system 100 may include machine-readable code instructions, parameters, and profiles 112 executed via hardware processing resources that may operate on servers or systems, remote data centers, or on-box in individual client information handling systems according to various embodiments herein. In some embodiments, it is understood any or all portions of machine-readable code instructions, parameters, and profiles 112 may operate on a plurality of information handling systems 100.

The information handling system 100 and/or the backend management server 170 may include hardware processing resources such as a hardware processor 102 (or a backend management server hardware processor 182), a central processing unit (CPU), accelerated processing unit (APU), a neural processing unit (NPU), a vision processing unit (VPU), the EC 104, a digital signal processor (DSP), a graphical processing unit (GPU) 154, a microcontroller, or any other type of hardware processing device that executes machine-readable code instructions to perform the processes described herein. Any of the hardware processing resources may operate to execute code that is either firmware or software code. Moreover, the information handling system 100 and/or the backend management server 170 can include memory such as main memory 104, static memory 108, and drive unit 120 (volatile (e.g., random-access memory, etc.), nonvolatile (read-only memory, flash memory etc.) or any combination thereof) that stores machine-readable code instructions, parameters, and profiles 112 including machine-readable code instructions, parameters, and profiles 112 of, in an example embodiment, automatic PD pairing management system pairing agent 156, and decrypting agent 192, the RNG algorithm 188, the PD assignment agent 180, automatic peripheral device pairing management system 158, or other computer executable program code as described in embodiments herein. A hardware controller (not shown) on the wireless peripheral device 186 may also execute code instructions of a counterpart automatic PD pairing management system pairing agent 156, the RNG algorithm 188, and pairing key data encryption agent 184. In embodiments described herein, computer-readable program code associated with the automatic PD pairing management system pairing agent 156, the automatic peripheral device pairing management system 158, the PD assignment agent 180, or the decrypting agent 192 may be stored on non-volatile memory such as main memory 104 or other memory such as static memory 108 and may be made to be accessible by a hardware processing device such as an EC 104 or the hardware processor 102 for execution. Similarly, wireless peripheral device 186 may also have memory to store code instructions and data. In one example embodiment, an information handling system may operate, in whole or in part, hardware processing resources executing code instructions of the automatic peripheral device pairing management system pairing agent 156 in coordination with the wireless peripheral device 186 according to embodiments herein.

As shown, the information handling system 100 and/or the backend management server 170 may further include a video display device 144. The video display device 144, in an embodiment, may function as a liquid crystal display (LCD), an organic light emitting diode (OLED), a flat panel display, or a solid-state display. Although FIG. 1 shows a single video display device 144 with the information handling system 100, the present specification contemplates that multiple video display devices 144 may be used with the information handling system 100 and/or the backend management server 170 to facilitate an extended desktop scenario, for example. In an embodiment, the video display device 144 may be used as an output device that allows the user to interact with the information handling system 100 and/or the backend management server 170. In one embodiment, the video display device 144 may be BT wirelessly coupled to the information handling system 100 via the methods described herein and via execution of the automatic PD pairing management system pairing agent 156, decrypting agent 192, and an OS BT stack by a hardware processing resource (e.g., EC 104, hardware processor 102, etc.).

In embodiments herein, the information handling system 100 may include one or more input/output devices 142 that may be wireless or wired including an alpha numeric input device such as a keyboard 146 and/or a cursor control device, such as a mouse 152, touchpad/trackpad 150, a stylus 148, or a gesture or touch screen input device associated with the video display device 144 that allow a user to interact with the images, windows, and applications presented to the user. In an embodiment, the video display device 144 may provide output to a user that includes, for example, one or more windows describing one or more instances of applications being executed by the hardware processor 102 of the information handling system 100 and/or backend management server hardware processor 182 of the backend management server 170.

In one example embodiment, a window may be presented to the user that provides a graphical user interface (GUI) representing the execution of an application or computer-readable program code described herein. The present disclosure contemplates that any of the input/output devices 142 may be a wireless peripheral device 186 ordered by and to be used by the user with the information handling system 100. For example, an user may order a new wireless mouse 152 to be shipped to the user's location and to be BT paired for use with the information handling system 100 as a wireless input/output device 142. The methods and systems described herein allow for a streamlined discovery, verification, and initialization of BT automatic pairing of the new wireless PDs 186 (e.g., wireless mouse 152) an information handling system 100 in a secure manner.

The information handling system 100 and/or the backend management server 170 may further include a network interface device. The network interface device may be a wired network interface card in some embodiments. The network interface device of the information handling system 100 as shown may also be a wireless interface adapter 128 according to another embodiment and can provide wireless connectivity among devices (e.g., wireless peripheral devices 186 such as the input/output devices 142) such as with Bluetooth® (BT) as well as wired network connectivity. Wired or wireless connectivity to a network 136 via a network interface device using, e.g., a wide area network (WAN), a local area network (LAN), wireless local area network (WLAN), a wireless personal area network (WPAN), a wireless wide area network (WWAN), or other network is contemplated in embodiments herein. In an embodiment, the WAN, WWAN, LAN, and WLAN may each include an access point 138 or base station 140 used to operatively couple the information handling system 100 to a network 136. In a specific embodiment, the network 136 may include macro-cellular connections via one or more base stations 138 or a wireless access point 138 (e.g., Wi-Fi or WiGig), or such as through licensed or unlicensed WWAN small cell base stations 138. Connectivity may be via wired or wireless connection. For example, wireless network access points 136 or base stations 138 may be operatively connected to the information handling system 100. Wireless interface adapter 128 may include one or more radio frequency (RF) subsystems (e.g., radio 130-1, 130-2) with transmitter/receiver circuitry, modem circuitry, one or more antenna front end circuits 132, one or more wireless controller circuits, amplifiers, antennas 134-1, 134-2 and other circuitry of the radio 130-1, 130-2 such as one or more antenna ports used for wireless communications via multiple radio access technologies (RATs). The radio 130-1, 130-2 may communicate with one or more wireless technology protocols. In one embodiment, the radio 130-1 operating as a WWAN module may contain individual subscriber identity module (SIM) profiles for each technology service provider and their available protocols for any operating subscriber-based radio access technologies such as cellular LTE communications. It is appreciated that the radios 130-1, 130-2 may be any type of wireless module operatively coupled to the RF front end 132 via, for example, I2C lines. These modules forming the radios 130-1, 130-2 include a WWAN module (e.g., radio 130-1), a WLAN module, a Bluetooth module (e.g., 130-2) or any other wireless protocol module used to operatively couple the information handling system 100 to a network or to the wireless peripheral device 186 or other wireless peripheral device 186 as described herein. It is appreciated that the backend management server 170 may also include a wireless interface adapter and radios similar to those of the information handling system 100 shown as well as wired network interface devices in order to allow for the information handling system 100 to be operatively coupled to the backend management server 170 as described herein.

In an example embodiment, the wireless interface adapter 128, radio 130-1, 130-2, and antenna 134-1, 134-2 may provide connectivity to one or more of the wireless peripheral devices 142, 186 that may include a wireless video display device 144, a wireless keyboard 146, a wireless mouse 152, a wireless headset, a microphone, a wireless stylus 148, and a wireless trackpad 150, among other wireless peripheral devices used as input/output (I/O) devices 142. For purposes of the present specification, the wireless peripheral device 186 is used as an example wireless peripheral device and may include any type of peripheral device of the wireless input/output devices 142 shown in FIG. 1.

It is appreciated that the various radios 130-1, 130-2 shown in FIG. 1 may be each coupled to an antenna 134-1, 134-2 via the RF front end 132. In an embodiment, the wireless interface adapter 128 may include any number of antennas 134-1, 134-2 which may include any number of tunable antennas for use with the system and methods disclosed herein. Although FIG. 1 shows two antennas 134-1, 134-2, the present specification contemplates that the number of antennas 134-1, 134-2 may include more or less of the number of individual antennas shown in FIG. 1. Additional antenna system modification circuitry (not shown) may also be included with the wireless interface adapter 128 to implement coexistence control measures via an antenna controller in various embodiments of the present disclosure.

In some aspects of the present disclosure, the wireless interface adapter 128 may operate two or more wireless links. In an embodiment, the wireless interface adapter 128 may operate a Bluetooth® wireless link (e.g., via Bluetooth radio 130-2 and antenna 134-2) using a Bluetooth® wireless or Bluetooth® Low Energy (BLE). In an embodiment, the Bluetooth® wireless protocol may operate at frequencies between 2.402 to 2.48 GHz.

The wireless interface adapter 128 may operate in accordance with any wireless data communication standards. To communicate with a wireless local area network, for example, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, or similar wireless standards may be used. Wireless interface adapter 128 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums.

The wireless interface adapter 128 can represent an add-in card, a wired network interface, or a wireless network interface module that is integrated with a main board of the information handling system 100 (and backend management server 170 in embodiments herein) or integrated with another wireless network interface capability, wired network interface capability, or any combination thereof. As described herein, a network interface device may include a wireless interface adapter 128 or a wired network interface card. In an embodiment the wireless interface adapter 128 may include one or more radio frequency subsystems including transmitters and wireless controllers for connecting via a multitude of wireless links. In an example embodiment, an information handling system 100 may have an antenna system transmitter for Bluetooth®, BLE, 5G small cell WWAN, or Wi-Fi WLAN connectivity and one or more additional antenna system transmitters for macro-cellular communication. The RF subsystems and radios 130-1, 130-2 include wireless controllers to manage authentication, connectivity, communications, power levels for transmission, buffering, error correction, baseband processing, and other functions of the wireless interface adapter 128.

As described herein, backend management server 170 may execute computer readable program code of a PD assignment agent 180 that, when executed by the backend management server hardware processor 182 or other hardware processing resource, manages the assignment of wireless peripheral devices 186 to individual information handling systems 100 by, in an example, directing that symmetric keys 194-B matching a symmetric key of the wireless peripheral device 186. The PD assignment agent 180, when executed by such hardware processing resources may cause assignment instructions to be transmitted to the automatic peripheral device pairing management system 158 executed by a backend management server hardware processor 182 on the backend management server 170 for the backend management server 170 to provide the symmetric keys 194-A, 194-B to a wireless peripheral device manufacturer 176 for the wireless peripheral device manufacturer 176 to store a symmetric key 194-A on a storage device of the wireless peripheral device 186 and/or deliver a symmetric key 194-B to the information handling system 100. Alternatively, the wireless peripheral device manufacturer 176 may be the entity that stores the symmetric key 194-A on a storage device of the wireless peripheral device 186 as well as pass, via a network 136 connection, a symmetric key 194-B to the information handling system 100 for automatic discovery, verification, and initialization of BT pairing with the wireless peripheral device 186. The information handling system 100 may then engage in a pairing query for automatic verification, and initiation of BT pairing to pair with the assigned wireless peripheral device 186 via execution of the automatic PD pairing management system pairing agent 156 with an OS BT stack in coordination with the wireless peripheral device 186 as described herein.

It is appreciated that the symmetric keys 164-A, 194-B are complementary symmetric keys that allow the information handling system 100 to receive symmetric key-wrapped secure pairing key data package used to automatically discover, verify, and initialize a BT pairing with the wireless peripheral device 186. The symmetric keys 194-A, 194-B, therefore, are unique to the information handling system 100 and wireless peripheral device 186 such that only the wireless peripheral device 186 that includes a symmetric key 194-A that matches or complements the symmetric key 194-B provided to the information handling system 100 that may be BT paired with the information handling system 100 with the symmetric key-wrapped secure pairing key data package. This prevents the wireless peripheral device 186 from being BT paired with another information handling system used by a user who did not purchase the wireless peripheral device 186 or is otherwise not allowed to use the wireless peripheral device 186 with their information handling system. Additionally, as described herein, the systems and methods used to automatically discover, verify, and initialize BT pairing of the wireless peripheral device 186 with the information handling system 100 prevent man-in-the-middle attacks from occurring by secretly securing the symmetric keys 194-A, 194-B in secure memory device locations such that no access can be gained by other devices or entities. Further, man-in-the-middle attacks are limited by using those symmetric keys 194-A, 194-B to decrypt a symmetric key-wrapped secure pairing key data package to yield a PD ID 168 and either a copy of the OOB temporary key 168 or seed 198 and index 199 data for the information handling system 100 to generate a copy of the OOB temporary key 168. Still further, the development of pairing OOB temporary keys by each of the wireless peripheral device 186 and information handling system 100 during the pairing process using the symmetric keys 194-A, 194-B limits the exposure of temporary key data to only after initiation of the BT pairing process thus also temporally limiting the exposure of this secure data.

By way of example, a user may engage in purchasing a wireless peripheral device 186 via a manufacturer's website or other purchasing means. As this occurs, the wireless peripheral device manufacturer 176 may be provided with certain purchasing data from the user. This purchasing data may include, in some example embodiments, a street address of the purchaser, a name of the purchaser, a unique customer number, or any other identification data that allows the wireless peripheral device manufacturer 176 to deliver the wireless peripheral device 186 to the user.

Concurrently, the wireless peripheral device manufacturer 176 may be provided with access to the user's information handling system 100 via a network 136 connection, for example, in order to send the information handling system 100 a symmetric key 194-B for later automatic discovery, verification, and initialization of the BT pairing processes described herein. This symmetric key 194-B may match or complement a symmetric key 194-A stored securely on a memory device of the wireless peripheral device 186 by the wireless peripheral device manufacturer 176. In an embodiment, the wireless peripheral device manufacturer 176 may use an information handling system such as the backend management server 170 that executes computer readable program code of the automatic peripheral device pairing management system 158 as well as other computer-readable program code such as a correlating software agent (e.g., Dell® SupportAssist®) to pass the symmetric key 194-B onto the information handling system 100. The information handling system 100 may store the symmetric key in a secure memory location such as, for example, a unified extensible firmware interface (UEFI) memory location to secure the symmetric key 194-B until use. The present specification contemplates, therefore, that the wireless peripheral device manufacturer 176 or a system management entity may operate a backend management server 170 to provide this symmetric key 194-B to the information handling system 100 or may rely on a third party operating a backend management server 170 to do the same.

When the wireless peripheral device manufacturer 176 stores the symmetric keys 194-A on the wireless peripheral device 186, the wireless peripheral device manufacturer 176 may also store a peripheral device identification (PD ID) 168 on a memory device of the wireless peripheral device 186. In an embodiment, the PD ID 168 may be a serial number assigned by the wireless peripheral device manufacturer 176 to the wireless peripheral device 186 that is unique to the wireless peripheral device 186. The uniqueness of the PD ID 168, therefore, is another layer of security such that execution of the systems and methods described herein, further prevents man-in-the-middle attacks. In an embodiment, the memory device on the wireless peripheral device 186 is a tamper-resistant data storage location and may include a masked gate array or a physically unclonable storage (PUS) device. Again, this prevents any person who physically intercepts the wireless peripheral device 186 during delivery from accessing the PD ID 168 and symmetrical key 194-A.

Concurrently, the wireless peripheral device manufacturer 176 may ship the wireless peripheral device 186 to the user. Again, the wireless peripheral device 186 may include a memory device where the matching or complementary symmetric key 194-A is stored. When the user receives the wireless peripheral device 186, the user may activate or otherwise turn on the wireless peripheral device 186 to initiate the pairing process described herein.

The use of the symmetric keys 194-A, 194-B to automatically discover, verify, and initialize BT pairing of the wireless peripheral device 186 to the information handling system 100 may include a number of example processes of embodiments herein. In an example embodiment, as the wireless peripheral device 186 is activated by the user, the wireless peripheral device 186 may execute, with a hardware microcontroller or any other type of hardware processing device, a random number generator (RNG) algorithm 188. The RNG algorithm 188 may generate an out-of-band (OOB) temporary key 166 used to automatically verify that the wireless peripheral device 186 is to be BT paired with the information handling system 100. The RNG algorithm 188, is a key generating algorithm that may use seed 198 and/or index 199 data in a hash-type function to generate the OOB temporary key 166 in embodiments herein. In one embodiment herein, the RNG algorithm 188 may also execute at the information handling system 100 to generate a corresponding OOB temporary key 166 with securely received seed 198 and index 199 data as well.

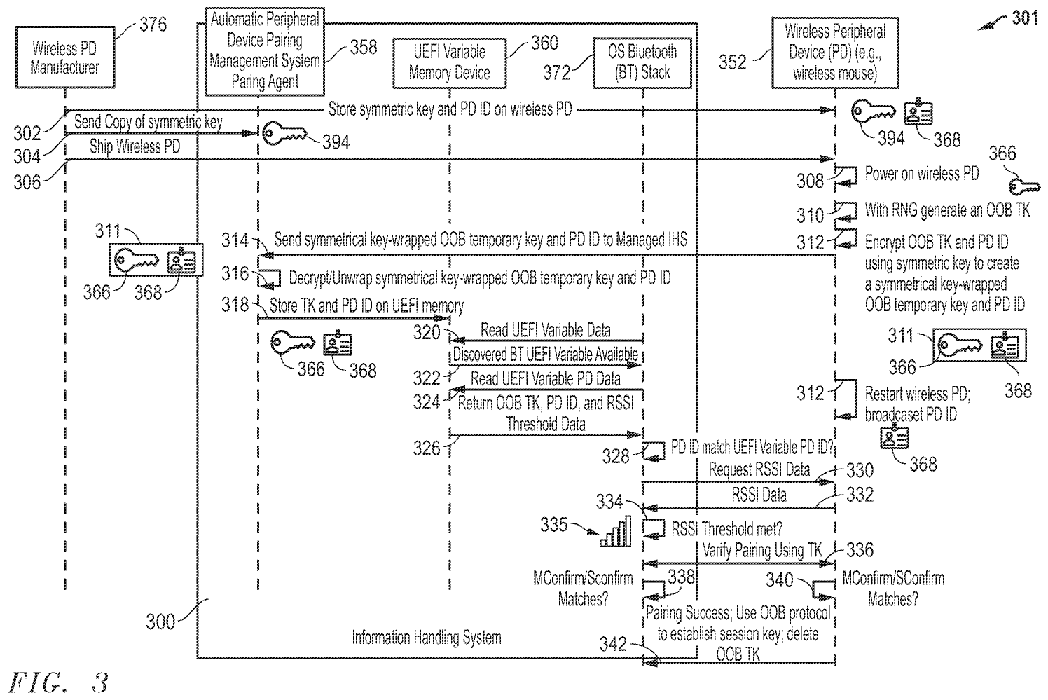

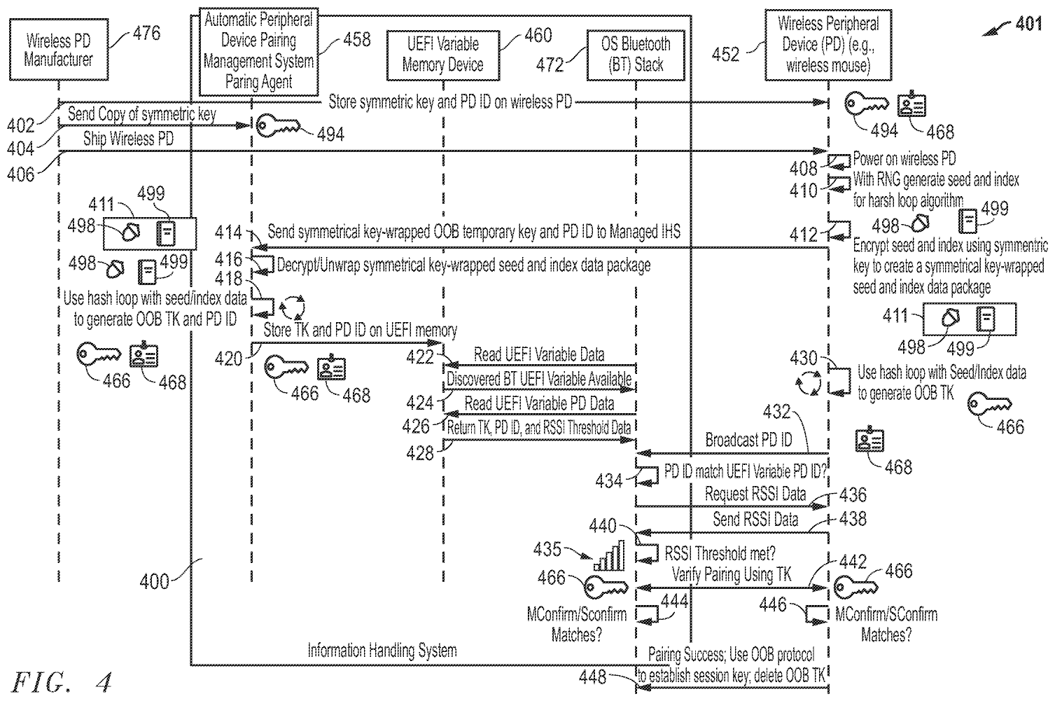

In one embodiment, the wireless peripheral device 186 may encrypt the created OOB temporary key 166 and PD ID 168 using the symmetric key 194-A to create a symmetrical key-wrapped OOB temporary key and PD ID (e.g., 311, FIG. 3). This symmetric key-wrapped secure pairing key data package may be a symmetrical key-wrapped OOB temporary key and PD ID that is now securely wrapped by the symmetric key 194 known only by the wireless peripheral device 186 and information handling system 100 preventing any other person such as a man-in-the-middle entity from retrieving the OOB temporary key 166 and PD ID 168 even if the symmetrical key-wrapped OOB temporary key and PD ID is obtained. In another embodiment, the wireless peripheral device 186 may encrypt the seed 198 and index 199 data and PD ID 168 using the symmetric key 194-A to create a symmetrical key-wrapped seed and index data and PD ID package (e.g., 411, FIG. 4). This symmetric key-wrapped secure pairing key data package may be a symmetrical key-wrapped seed and index data and PD ID that is now securely wrapped by the symmetric key 194 known only by the wireless peripheral device 186 and information handling system 100.

At this point, the information handling system 100 receives the symmetrical key-wrapped GOB temporary key and PD ID and unwraps by executing computer-readable program code of a decryption agent 192 using the symmetric key 194-B that matches or complements the symmetric key 194-A of the wireless peripheral device 186. By unwrapping the symmetrical key-wrapped OOB temporary key and PD ID, the information handling system 100 retrieves its own copy of the OOB temporary key 166 and PD ID 168 in one embodiment. In another embodiment, by unwrapping the symmetrical key-wrapped seed and index data and PD ID, the information handling system may use the seed and index data with the RNG algorithm to generate a copy of the OOB temporary key 166. The OOB temporary key 166 and PD ID 168, therefore, match the OOB temporary key 166 generated by the execution of the random number generator 188 by the wireless peripheral device 186 and the PD ID 168 stored on the memory device of the wireless peripheral device 186.

Upon unwrapping the OOB temporary key 166 and PD ID 168 or pairing key data to generate the same, the information handling system 100 may store the OOB temporary key 166 and PD ID 168 in a unified extensible firmware interface (UEFI) memory device 160 as UEFI variable data 162 or store the OOB temporary key 166 and PD ID 168 in other secure memory locations in various memory devices in various embodiments. The UEFI memory device 160 on the information handling system 100 may be any memory device that maintains the PD ID 168 and OOB temporary key 166 for later retrieval by an operating system (OS) Bluetooth® (BT) stack (e.g., 372, FIG. 3) under direction of a hardware processor (e.g., hardware processor 102) in one embodiment. In an embodiment, the UEFI variable data 162 is stored on a flash memory device associated with the basic input/output system (BIOS) 114.

In an embodiment, the OS BT stack includes computer executable program code with hardware that, when executed by a hardware processor (e.g., hardware processor 102, embedded controller 104, or any other hardware processing resource) along with code instructions of the automatic peripheral device pairing management system pairing agent 156 of the information handling system 100, performs automatic querying, verification, and initiation of BT pairing operations between the information handling system 100 and wireless peripheral device 186, and controls operations of a Bluetooth radio 130-2 under any BT protocols, among other functions. A plurality of protocols may be present in the Bluetooth stack which may include core protocols including Bluetooth radio, baseband, link manage protocol, logical link control and adaptation protocol, and service discovery protocols. Further, the protocols present with the Bluetooth stack include adopted protocols such as those protocols adopted from standard models (e.g., Point-to-Point Protocol, Internet Protocol, User Datagram Protocol, Transmission Control Protocol, and Wireless Application Protocol). Attention command sets may also be part of the protocols associated with the Bluetooth stack. Physical layers of the Bluetooth stack also include a radio (e.g., Bluetooth radio 130-2) used to transmit radio waves at a specific frequency as described herein. The frequency with which the Bluetooth stack of the Bluetooth radio 130-2 queries the UEFI variable data 162 to determine if OOB temporary key 166 and PD ID 168 data is available may vary. In an embodiment, the Bluetooth stack may query the UEFI memory device 160 for the UEFI variable data 162 during every power up of the information handling system 100. In an embodiment, the Bluetooth stack may query the UEFI variable data 162 on the UEFI memory device 160 a plurality of times when the information handling system 100 is powered up.

In an embodiment, the wireless peripheral device 186, after sending the symmetrical key-wrapped pairing key data that is symmetrical key-wrapped seed and index data and PD ID or symmetrical key-wrapped OOB temporary key and PD ID may reset. This resetting process may be a process that places the wireless peripheral device 186 in a state to broadcast the PD ID 168 to the information handling system 100 after a certain length of time to allow the information handling system 100 to conduct the unwrapping process described herein. In an embodiment, the wireless peripheral device 186 may not reset and, instead, may wait for a period of time before broadcasting the PD ID 168 so that the information handling system 100 may unwrap the symmetrical key-wrapped seed and index data and PD ID or the symmetrical key-wrapped OOB temporary key and PD ID, store the resulting OOB temporary key 166 and PD ID 168 on the UEFI memory device, and cause the OS BT stack to access the OOB temporary key 166 and PD ID 168.

When the wireless peripheral device 186 broadcasts the PD ID 168, via an OOB BT broadcast, that broadcasting indicates the availability of the wireless peripheral device 186 to pair with the information handling system 100 to the information handling system 100. In an embodiment, this broadcast includes a pairing request to the information handling system 100 to BT pair with the wireless peripheral device 186. In the embodiments herein, the OS BT stack associated with the Bluetooth radio 130-2 may detect this PD ID 168 and, via execution of code instructions of the automatic peripheral device pairing management system pairing agent 156 of the information handling system 100, compare it to the PD ID 168 received from the unwrapping of the symmetrical key-wrapped seed and index data and PD ID or the symmetrical key-wrapped GOB temporary key and PD ID and stored on the UEFI memory device. In an embodiment, the PD ID 168 stored in the UEFI memory device 160 and accessed by the OS BT stack may be one of a plurality of PD IDs 168 when, for example the user had purchased a plurality of wireless peripheral devices 186 and the symmetric key 194-B or a plurality of different symmetric keys 194-B were provided to the information handling system 100 for automatic querying, verification, and BT pairing with these plurality of ordered wireless peripheral devices 186.

Again, because the symmetrical key-wrapped OOB temporary key and PD ID or the symmetrical key-wrapped seed and index data and PD ID was unwrapped by the information handling system 100 via execution of the decrypting agent 192, the PD ID 168 used to compare with the broadcasted PD ID 168 from the wireless peripheral device 186 is also correlated to a corresponding OOB temporary key 166 for the wireless peripheral device 186 identified as the querying wireless peripheral device 186. Where the PD ID 168 provided by the wireless peripheral device 186 does not match the PD ID 168 accessed by the Bluetooth stack of the Bluetooth radio 130-2, the pairing process is not completed. Where the broadcasted PD ID 168 provided by the wireless peripheral device 186 matches the PD ID 168 stored in the UEFI memory device 160, the automatic verification and initiation of BT pairing process may proceed via execution of code instructions of the automatic peripheral device pairing management system pairing agent 156.

In an embodiment, the Bluetooth stack of the Bluetooth radio 130-2 may request certain received signal strength indicator (RSSI) data signal (e.g., 335, FIG. 3) from the wireless peripheral device 186. RSSI data signal is received by the BT radio 130-2 of the information handling system 100 and the power level being received from the radio at the wireless peripheral device 186 (e.g., after calculated antenna and cable loss) can be determined. RSSI threshold data received by the wireless interface adapter of the information handling system 100 indicates whether, in an embodiment, the wireless peripheral device 186 is within a threshold range of the information handling system 100. In an embodiment where multiple wireless peripheral devices 186 are activated near the information handling system 100, the RSSI threshold may prevent other wireless peripheral devices 186 that are not within a threshold distance of the user's information handling system 100 from initiating automatic BT pairing. The RSSI power level provided by the wireless peripheral device 186 may be compared to an RSSI threshold value set at the Bluetooth radio 130-2 of the information handling system 100. Where the wireless peripheral device 186 RSSI value does not meet or exceed the RSSI threshold value, the information handling system 100 may ignore the pairing request of the wireless peripheral device 186. Where the RSSI value meets or exceeds the RSSI threshold value, the OS BT stack of the Bluetooth radio 130-2 within the information handling system 100 may continue the automatic verification and initiation of BT pairing process to establish a BT wireless link.

The automatic verification and initiation of the BT pairing process, in an embodiment, is executed by code instructions of the automatic peripheral device pairing management system pairing agent 156 of the information handling system 100 and includes the information handling system 100 verifying that the OOB temporary key 166 matches the OOB temporary key 166 stored at the wireless peripheral device 186 attempting to BT pair with the information handling system 100. This may be done with a process where the OOB temporary key 166 is used to encrypt a message or data sent to the wireless peripheral device 186 and the OOB temporary key 166 is used to decrypt the message and a message is encrypted and decrypted in the reverse between the wireless peripheral device 186 and the information handling system 100 as well. This exchange of message values encrypted and decrypted at both sides of the BT pairing may be conducted according to a confirm value generation function in various embodiments. With such encryption and decryption if the messages match, the OOB temporary key 166 and OOB temporary key 166 on the wireless peripheral device 186 may be verified as matching in one example embodiment. In an embodiment, the automatic verification and initiation of the BT pairing process may use a Bluetooth out-of-band (OOB), a legacy BLE GOB pairing, a Bluetooth Low Energy (BLE) GOB pairing protocol, or any other suitable protocol to verify and then to BT pair the wireless peripheral device 186 to the information handling system 100 and set up a BT wireless link with a session key. In an embodiment, the information handling system 100 and wireless peripheral device 186 can each provide various automatic querying, verification, and BT pairing communications that includes the OOB temporary key 166 verification and a pairing response command via an OOB BT communication prior to establishing a BT wireless link with a secure session key under any of the BT standards.

In an example embodiment, the information handling system 100 may encrypt an Mconfirm value from its copy of the OOB temporary key 166 via a an encryption algorithm, provide encrypted Mconfirm to the wireless peripheral device 186, for decryption at the wireless peripheral device 186 its own stored copy of the OOB temporary key 166. Further, the decrypted Mconfirm value may be used as an Sconfirm value encrypted at the wireless peripheral device 186 and sent to the information handling system 100 for decryption using the GOB temporary key 166 to determine the sent Sconfirm value. A match of the received Sconfirm from the wireless peripheral device 186 with the Mconfirm from the information handling system 100 may be used as verification in such an example embodiment. Where the values match, the BT pairing process establishes a session key and a BT wireless link via the OS BT stack and BT protocols. Then the BT pairing process is completed between the wireless peripheral device 186 and information handling system 100. In an embodiment, once the wireless peripheral device 186 is paired with the information handling system 100, the OOB temporary key 166 is no longer used and the OOB temporary key 166 on both the information handling system 100 and the wireless peripheral device 186 may be deleted. Thus, in an embodiment, the OOB temporary key 166 may be a single use temporary key in some embodiments.

Again, the use of the symmetric keys 194-A, 194-B to automatically discover, verify, and initialize BT pairing of the wireless peripheral device 186 to the information handling system 100 may include another example processes. In an example embodiment, as the wireless peripheral device 186 is activated by the user, the wireless peripheral device 186 may execute, with a hardware microcontroller or any other type of hardware processing device, the RNG algorithm 188. Execution of the RNG algorithm 188 by the hardware processor of the wireless peripheral device 186 causes the RNG algorithm 188 to create a seed 198 value and an index 199 value. The seed 198 value and index 199 value are used along with a hash loop algorithm during the pairing processes described herein. The seed 198 value may be used as an initialization vector to inform a hash loop algorithm where to start the hash loop algorithm and the index 199 value informs the hash loop algorithm the number of times to re-concatenate the hash loop algorithm. The hash loop algorithm described herein may include hash algorithms such as Secure Hash Algorithm (SHA)-256, SHA 2, SHA-3 among others.

As described, at this point the seed 198 and index 199 values are created, the pairing key data encryption agent 184 may encrypt the seed 198 value and the index 199 value, along with the PD ID 168, using the symmetric key 194-A. This encryption of the index 199 value and index 199 value creates the symmetrical key-wrapped seed and index data and PDID package (e.g., 411, FIG. 4) as described. This symmetrical key-wrapped seed and index data package may be broadcast to the information handling system 100.

At this point, the information handling system 100 receives the symmetrical key-wrapped seed and index data package and PD ID 168 and proceeds to unwrap the symmetrical key-wrapped seed and index data package by executing computer-readable program code of the decryption agent 192 using the symmetric key 194-B that matches or complements the symmetric key 194-A of the wireless peripheral device 186. By unwrapping the symmetrical key-wrapped seed and index data package, the information handling system 100 retrieves its own copy of the seed 198 value and the index 199 value. At this point, the hardware processor 102, EC 104, or other hardware processor executes the computer-readable program code of the decrypting agent 192 to execute the same hash loop algorithm the wireless peripheral device 186 used to create the seed 198 value and index 199 value. The execution of the hash loop algorithm creates a unique OOB temporary key 166 and PD ID 168. The OOB temporary key 166 and PD ID 168, therefore, match the OOB temporary key 166 generated by the execution of the hash loop algorithm described herein by the wireless peripheral device 186 and the PD ID 168 stored on the memory device of the wireless peripheral device 186.

Upon unwrapping the symmetrical key-wrapped seed and index data package and generating the OOB temporary key 166 via execution of the hash loop algorithm, the information handling system 100 may store the OOB temporary key 166 and PD ID 168 in the UEFI memory device 160 as UEFI variable data 162 or store the OOB temporary key 166 and PD ID 168 in other secure memory locations in various memory devices in various embodiments. The UEFI memory device 160 on the information handling system 100 may be any memory device that maintains the PD ID 168 and OOB temporary key 166 for later retrieval by an operating system (OS) Bluetooth® (BT) stack (e.g., 472, FIG. 4) under direction of a hardware processor (e.g., hardware processor 102) in one embodiment. In an embodiment, the UEFI variable data 162 is stored on a flash memory device associated with the basic input/output system (BIOS) 114 of the information handling system 100.

In an embodiment, the OS BT stack includes computer executable program code with hardware that, when executed by a hardware processor (e.g., hardware processor 102, embedded controller 104, or any other hardware processing resource) along with code instructions of the automatic peripheral device pairing management system pairing agent 156 of the information handling system 100, performs automatic querying, verification, and initiation of BT pairing operations between the information handling system 100 and wireless peripheral device 186, and controls operations of a Bluetooth radio 130-2 under any BT protocols, among other functions. A plurality of protocols may be present in the Bluetooth stack which may include core protocols including Bluetooth radio, baseband, link manage protocol, logical link control and adaptation protocol, and service discovery protocols. Further, the protocols present with the Bluetooth stack include adopted protocols such as those protocols adopted from standard models (e.g., Point-to-Point Protocol, Internet Protocol, User Datagram Protocol, Transmission Control Protocol, and Wireless Application Protocol). Attention command sets may also be part of the protocols associated with the Bluetooth stack. Physical layers of the Bluetooth stack also include a radio (e.g., Bluetooth radio 130-2) used to transmit radio waves at a specific frequency as described herein. The frequency with which the Bluetooth stack of the Bluetooth radio 130-2 queries the UEFI variable data 162 to determine if OOB temporary key 166 and PD ID 168 data is available may vary. In an embodiment, the Bluetooth stack may query the UEFI memory device 160 for the UEFI variable data 162 during every power up of the information handling system 100. In an embodiment, the Bluetooth stack may query the UEFI variable data 162 on the UEFI memory device 160 a plurality of times when the information handling system 100 is powered up.

In an embodiment, the wireless peripheral device 186, after sending the symmetrical key-wrapped OOB temporary key and PD ID may also use the hash loop algorithm along with the seed 198 value and index 199 value to generate the same OOB temporary key 166 as that generated at the information handling system 100. Because the seed 198 value, index 199 value, and hash loop algorithm are the same at the information handling system 100 and the wireless peripheral device 186, the same OOB temporary key 166 is created for use by the wireless peripheral device 186 and information handling system 100 to verify BT pairing. At this point, the wireless peripheral device 186 may broadcast the PD ID 168 to the information handling system 100 to continue with the pairing process.

When the wireless peripheral device 186 broadcasts the PD ID 168, via an OOB BT broadcast, that broadcasting indicates the availability of the wireless peripheral device 186 to pair with the information handling system 100 to the information handling system 100. In an embodiment, this broadcast includes a pairing request to the information handling system 100 to BT pair with the wireless peripheral device 186. In the embodiments herein, the OS BT stack associated with the Bluetooth radio 130-2 may detect this PD ID 168 and, via execution of code instructions of the automatic peripheral device pairing management system pairing agent 156 of the information handling system 100, compare it to the PD ID 168 received from the unwrapping of the symmetrical key-wrapped seed and index data package and PD ID and stored on the UEFI memory device. In an embodiment, the PD ID 168 stored in the UEFI memory device 160 and accessed by the OS BT stack may be one of a plurality of PD IDs 168 when, for example the user had purchased a plurality of wireless peripheral devices 186 and the symmetric key 194-B or a plurality of different symmetric keys 194-B were provided to the information handling system 100 for automatic querying, verification, and BT pairing with these plurality of ordered wireless peripheral devices 186.

Again, because the symmetrical key-wrapped seed and index data package was unwrapped by the information handling system 100 via execution of the decrypting agent 192, the PD ID 168 used to compare with the broadcasted PD ID 168 from the wireless peripheral device 186 is also correlated to a corresponding OOB temporary key 166 for the wireless peripheral device 186 identified as the querying wireless peripheral device 186. Where the PD ID 168 provided by the wireless peripheral device 186 does not match the PD ID 168 accessed by the Bluetooth stack of the Bluetooth radio 130-2, the pairing process is not completed. Where the broadcasted PD ID 168 provided by the wireless peripheral device 186 matches the PD ID 168 stored in the UEFI memory device 160, the automatic verification and initiation of BT pairing process may proceed via execution of code instructions of the automatic peripheral device pairing management system pairing agent 156.

In an embodiment, the Bluetooth stack of the Bluetooth radio 130-2 may request certain received signal strength indicator (RSSI) data signal (e.g., 335, FIG. 3) from the wireless peripheral device 186. RSSI data signal is received by the BT radio 130-2 of the information handling system 100 and the power level being received from the radio at the wireless peripheral device 186 (e.g., after calculated antenna and cable loss) can be determined. RSSI threshold data received by the wireless interface adapter of the information handling system 100 indicates whether, in an embodiment, the wireless peripheral device 186 is within a threshold range of the information handling system 100. In an embodiment where multiple wireless peripheral devices 186 are activated near the information handling system 100, the RSSI threshold may prevent other wireless peripheral devices 186 that are not within a threshold distance of the user's information handling system 100 from initiating automatic BT pairing. The RSSI power level provided by the wireless peripheral device 186 may be compared to an RSSI threshold value set at the Bluetooth radio 130-2 of the information handling system 100. Where the wireless peripheral device 186 RSSI value does not meet or exceed the RSSI threshold value, the information handling system 100 may ignore the pairing request of the wireless peripheral device 186. Where the RSSI value meets or exceeds the RSSI threshold value, the OS BT stack of the Bluetooth radio 130-2 within the information handling system 100 may continue the automatic verification and initiation of BT pairing process to establish a BT wireless link.

The automatic verification and initiation of the BT pairing process, in an embodiment, is executed by code instructions of the automatic peripheral device pairing management system pairing agent 156 of the information handling system 100 and includes the information handling system 100 verifying that the OOB temporary key 166 matches the OOB temporary key 166 stored at the wireless peripheral device 186 attempting to BT pair with the information handling system 100. This may be done with the process disclosed in embodiments herein where the OOB temporary key 166 is used to encrypt a message or data sent to the wireless peripheral device 186 and the OOB temporary key 166 is used to decrypt the message and a message is encrypted and decrypted in the reverse between the wireless peripheral device 186 and the information handling system 100 with the confirm value generation function. With such encryption and decryption if the messages match, the OOB temporary key 166 and OOB temporary key 166 on the wireless peripheral device 186 may be verified as matching in one example embodiment. In an embodiment, the automatic verification and initiation of the BT pairing process may use a Bluetooth out-of-band (OOB), a legacy BLE GOB pairing, a Bluetooth Low Energy (BLE) GOB pairing protocol, or any other suitable protocol to verify and then to BT pair the wireless peripheral device 186 to the information handling system 100 to establish a BT wireless link secured with a session key. In an embodiment, the information handling system 100 and wireless peripheral device 186 can each provide various automatic querying, verification, and BT pairing communications that includes the OOB temporary key 166 verification and a pairing response command via an OOB BT communication.

In an example embodiment, the information handling system 100 may encrypt an Mconfirm value from its copy of the OOB temporary key 166 via a an encryption algorithm, provide encrypted Mconfirm to the wireless peripheral device 186, for decryption at the wireless peripheral device 186 its own stored copy of the OOB temporary key 166. Further, the decrypted Mconfirm value may be used as an Sconfirm value encrypted at the wireless peripheral device 186 and sent to the information handling system 100 for decryption using the GOB temporary key 166 to determine the sent Sconfirm value. A match of the received Sconfirm from the wireless peripheral device 186 with the Mconfirm from the information handling system 100 may be used as verification in such an example embodiment. Where the values match, the BT pairing process establishes a session key and a BT wireless link via the OS BT stack and BT protocols. Then the BT pairing process is completed between the wireless peripheral device 186 and information handling system 100. In an embodiment, once the wireless peripheral device 186 is paired with the information handling system 100, the OOB temporary key 166 is no longer used and the OOB temporary key 166 on both the information handling system 100 and the wireless peripheral device 186 may be deleted. Thus, in an embodiment, the OOB temporary key 166 may be a single use temporary key in some embodiments.

The systems and methods described herein allows for a secure method of BT pairing a wireless peripheral device 186. The method allows an information handling system 100 to receive one of a symmetrical key-wrapped OOB temporary key and PD ID or symmetrical key-wrapped seed and index data package and a PD ID 168 as a symmetrical key-wrapped pairing key data that is to be unwrapped and/or used to create an OOB temporary key 166 at both the information handling system 100 and wireless peripheral device 186. The reciprocal OOB temporary keys 166 are to be matched so that a BT pairing request may be initiated and completed automatically. As such the symmetric key 194 and the resulting OOB temporary key 166 are secured and controlled until the wireless peripheral device 186 broadcasts the symmetrical key-wrapped OOB temporary key and PD ID or symmetrical key-wrapped seed and index data package as described herein. This allows the wireless peripheral device manufacturer 176, a backend management server 170, and a wireless peripheral device 186 to secure the data used to BT pair the wireless peripheral device 186 to the information handling system 100 at all times.

The systems and methods described herein also provide for a backend management server 170 executing a PD assignment agent 180 via a hardware processing resource or a wireless peripheral device manufacturer 176 to assign a wireless peripheral device 186 or even a plurality of wireless peripheral devices 186 to an specific information handling system 100 by controlling which information handling system 100 will be given the symmetric key 194-B that matches a symmetrical key 194-A on the wireless peripheral device 186 according to some embodiments.

In an embodiment, the information handling system 100 and/or the backend management server 170 can include one or more sets of machine-readable code instructions, parameters, and profiles 112 that can be executed to cause the computer system to perform any one or more of the methods or computer-based functions disclosed herein. For example, machine-readable code instructions, parameters, and profiles 112 may execute, via hardware processing resources, various software applications, software agents, the BIOS 114 firmware and/or software, or other aspects or components. Machine-readable code instructions, parameters, and profiles 112 may execute, via the backend management server hardware processor 182 or any other hardware processing device, the PD assignment agent 180 at the backend management server 170 which controls the assigning of symmetrical keys 194-B to information handling systems 100 so that automatic querying, verification, and initiation of BT pairing of wireless peripheral devices 186 with the information handling systems 100 can be accomplished in embodiments herein. Still further, machine-readable code instructions, parameters, and profiles 112 may execute, via the hardware processor 102, EC 104, or any other hardware processing device, the automatic PD pairing management system pairing agent 156 at each of the information handling systems 100 which manages the pairing of assigned wireless peripheral devices 186 to the information handling system 100 via the automatic querying, verification, and initiation of BT pairing of wireless peripheral devices 186 to the information handling systems 100 as described herein. Still further, machine-readable code instructions, parameters, and profiles 112 may execute, via the hardware processor 102, EC 104, or any other hardware processing device, the random number generator 188 and OOB temporary key encryption agent 184 of the wireless peripheral device 186 to generate symmetrical key-wrapped OOB temporary key and PD ID or symmetrical key-wrapped seed and index data package to complete the BT pairing process. Again, the machine-readable code instructions, parameters, and profiles 112 described herein may be stored on a non-volatile memory device and made accessible to the EC 104, the hardware processor 104, a microcontroller unit (MCU), or other hardware processing resource for execution. Various software modules comprising application instructions of machine-readable code instructions, parameters, and profiles 112 may be coordinated by an operating system (OS) 116, and/or via an application programming interface (API). An example OS 116 may include Windows®, Android®, and other OS types known in the art. Example APIs may include Win 32, Core Java API, or Android APIs.

In an embodiment, the disk drive unit 120 and may include machine-readable code instructions, parameters, and profiles 112 in which one or more sets of machine-readable code instructions, parameters, and profiles 112 such as software can be embedded to be executed by the processor 102 or other hardware processing devices such as a GPU 154 to perform the processes described herein. Similarly, main memory 106 and static memory 108 may also contain a computer-readable medium for storage of one or more sets of machine-readable code instructions, parameters, or profiles 112 described herein. The disk drive unit 120 or static memory 108 also contain space for data storage. Further, the machine-readable code instructions, parameters, and profiles 112 may embody one or more of the methods as described herein. In a particular embodiment, the machine-readable code instructions, parameters, and profiles 112 may reside completely, or at least partially, within the main memory 106, the static memory 108, and/or within the disk drive 120 during execution by the hardware processor 102, EC 104, or GPU 154 of information handling system 100. The main memory 106, GPU 154, EC 104, and the hardware processor 102 also may include computer-readable media.

Main memory 106 or other memory of the embodiments described herein may contain computer-readable medium (not shown), such as RAM in an example embodiment. An example of main memory 106 includes random access memory (RAM) such as static RAM (SRAM), dynamic RAM (DRAM), non-volatile RAM (NV-RAM), or the like, read only memory (ROM), another type of memory, or a combination thereof. Static memory 108 may contain computer-readable medium (not shown), such as NOR or NAND flash memory in some example embodiments. The applications and associated APIs, for example, may be stored in static memory 108 or on the disk drive unit 120 that may include access to a machine-readable code instructions, parameters, and profiles 112 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 and/or the backend management server 170 may further include a power management unit (PMU) 122 (a.k.a. a power supply unit (PSU)). The PMU 122 may include a hardware controller and executable machine-readable code instructions to manage the power provided to the components of the information handling system 100 such as the hardware processor 102, and other hardware components described herein. The PMU 122 may control power to one or more components including the one or more drive units 120, the hardware processor 102 (e.g., CPU), the EC 104, the GPU 154, a video/graphic display device 144 or other wired input/output devices 142 such as the stylus 148, a mouse 152, a keyboard 146, and a trackpad 150 and other components that may require power when a power button has been actuated by a user. In an embodiment, the PMU 122 may monitor power levels and be electrically coupled, either wired or wirelessly, to the information handling system 100 and/or the backend management server 170 to provide this power and coupled to bus 118 to provide or receive data or machine-readable code instructions. The PMU 122 may regulate power from a power source such as a battery 124 or AC power adapter 126. In an embodiment, the battery 124 may be charged via the AC power adapter 126 and provide power to the components of the information handling system 100 and/or the backend management server 170, via a wired connections as applicable, or when AC power from the AC power adapter 126 is removed. PMU 122 may include a hardware controller to operate with the EC 104 separately or together to execute machine-readable code instructions, parameters, and profiles 112 of the PD assignment agent 180 at the backend management server 170 and the automatic PD pairing management system pairing agent 156 at the information handling system 100 as described herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® Core class processor, ARM® brand processors, Qualcomm® Snapdragon processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

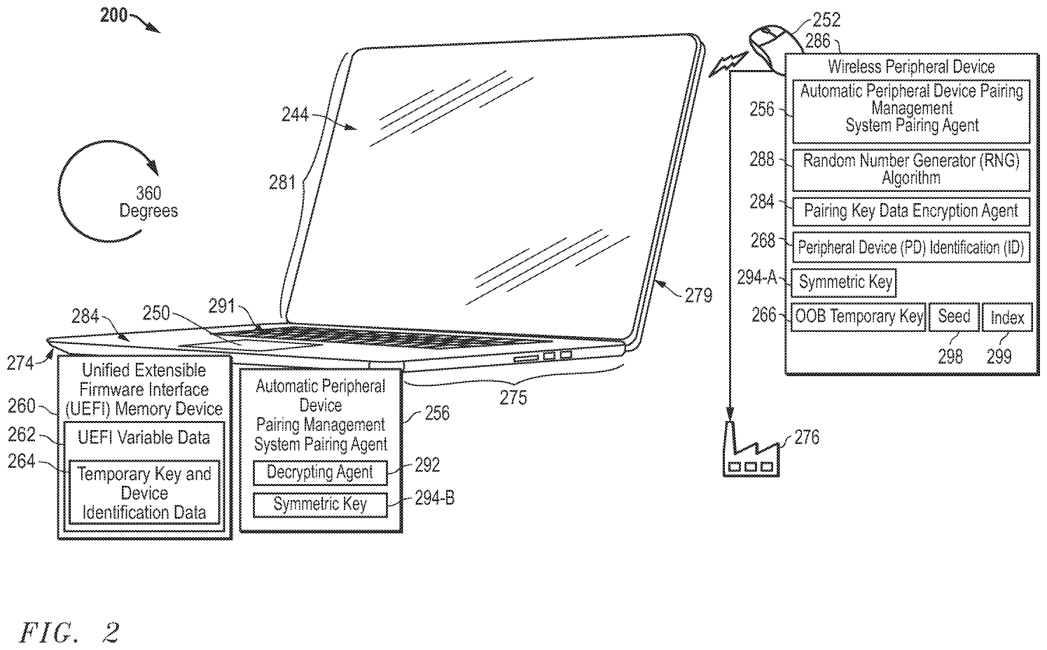

FIG. 2 is a graphic diagram of an information handling system 200 pairable with one or more wireless peripheral devices 252 manufactured and distributed by a wireless peripheral device manufacturer 276 according to an embodiment of the present disclosure. It is appreciated that any type of peripheral device may be wirelessly coupled to the information handling system 200 and may include any wireless input/output device shown in FIG. 1 such as a wireless video display device (e.g., external video display device), a wireless stylus, a wireless trackpad, and other similar devices.

The information handling system 200 may, in an example embodiment, be a laptop-type information handling system 200. The information handling system 200 may, in an example embodiment, be a 360°-type information handling system 200. In the example shown in FIG. 2, the information handling system 200 may be a 3600 information handling system 200 where an exterior surface of the bottom cover or bottom chassis 274 of a base chassis 275 may be brought towards an exterior side of the back display chassis 279 of the display chassis 281 to place the information handling system 200 in a tablet configuration in one embodiment. As shown in FIG. 2, the information handling system 200 may also be placed in a laptop configuration where the base chassis 275 is lying flat on a surface with the display chassis 281 being placed upright from the base chassis 275. Other configurations such as a dual tablet configuration and a tent orientation are contemplated as described herein.

The information handling system 200 may include a plurality of chassis made of metal, plastic, or the like. The information handling system 200, in an embodiment, may comprise an outer case or shell of an information handling system 200 for housing internal components of the information handling system 200, such as a video display device 244 (e.g., a built-in video display device 244), a cursor control device (e.g., built-in trackpad or touchpad 250), and an alpha numeric input device (e.g., built-in keyboard 291). As shown in FIG. 2, the information handling system 200 may include a built-in video display device 244 functioning to enclose the display chassis 281 with the back display chassis 279 described herein.

As another example, the information handling system 200 may further include the keyboard chassis 284 functioning to enclose a cursor control device such as a trackpad 250 and/or the built-in keyboard 291 acting as an alpha numeric input device. The back display chassis 279 and the video display device 244 may be joined together in an embodiment to form a fully enclosed display chassis 281, while the keyboard chassis 284 and a bottom chassis 274 may be joined together to form a fully enclosed base chassis 275. Taking a closed configuration as a reference position of the video display device 244 including the back display chassis 279 and the base chassis 275 including the keyboard chassis 284 and bottom chassis 274, the video display device 244 and back display chassis 279 may be rotated away from the base chassis 275 into the laptop configuration as shown in FIG. 2.

As described herein, the wireless peripheral device manufacturer 276 shown in FIG. 2 may be the entity that stores a symmetric key 294-A on a storage device of the wireless peripheral device 252 (e.g., a wireless mouse in the example embodiment of FIG. 2) as well as pass, via a network connection, a symmetric key 294-B to the information handling system 200 for automatic discovery, verification, and initialization of BT pairing with the wireless peripheral device 252. The information handling system 200 may then engage in a pairing query for automatic verification, and initiation of BT pairing to pair with the assigned wireless peripheral device 252 via execution of the automatic PD pairing management system pairing agent 256 with an OS BT stack as described herein.

It is appreciated that the symmetric keys 294-A, 294-B are complementary symmetric keys that allow the information handling system 200 to receive and decrypt symmetrical key-wrapped pairing key data with a PD ID as well as an OOB temporary key or seed 198 and index 199 data to generate the same from a wireless peripheral device 252. This received symmetrical key-wrapped pairing key data, once unwrapped as pairing key data, may be used to automatically discover, verify, and initialize a BT pairing with the wireless peripheral device 252. The symmetric keys 294-A, 294-B, therefore, are unique to the information handling system 200 and wireless peripheral device 252 such that only the wireless peripheral device 252 that includes a symmetric key 294-A that matches or complements the symmetric key 294-B provided to the information handling system 200 may be BT paired with the information handling system 200. This prevents the wireless peripheral device 252 from being BT paired with another information handling system used by a user who did not purchase the wireless peripheral device 252 or is otherwise not allowed to use the wireless peripheral device 252 with their information handling system. Additionally, as described herein, the systems and methods used with a OOB temporary key 266 and PD ID 268 to automatically discover, verify, and initialize BT pairing of the wireless peripheral device 252 with the information handling system 200 prevent man-in-the-middle attacks from occurring. Further, by secretly securing the symmetric keys 294-A, 294-B in secure memory device locations such that no access can be gained by other devices or entities provides an additional layer of security. Still further, the development of pairing OOB temporary keys 266 by each of the wireless peripheral device 252 and information handling system 200 after initiation and during the pairing process using the symmetric keys 294-A, 294-B limits the temporal exposure of OOB temporary key data 266 to only during the initial verification and BT pairing process.

By way of example, a user may engage in purchasing a wireless peripheral device 252 via a manufacturer's website or other purchasing means. As this occurs, the wireless peripheral device manufacturer 276 may be provided with certain purchasing data from the user. This purchasing data may include, in some example embodiments, a street address of the purchaser, a name of the purchaser, a unique customer number, or any other identification data that allows the wireless peripheral device manufacturer 276 to deliver the wireless peripheral device 252 to the user.

Concurrently, the wireless peripheral device manufacturer 276 may be provided with access to the user's information handling system 200 via a network 236 connection, for example, in order to send the information handling system 200 a symmetric key 294-B for later automatic discovery, verification, and initialization of the BT pairing processes described herein. This symmetric key 294-B may match or complement a symmetric key 294-A stored securely on a memory device of the wireless peripheral device 252 by the wireless peripheral device manufacturer 276. In an embodiment, the wireless peripheral device manufacturer 276 may use an information handling system such as the backend management server 270 that executes computer readable program code of the automatic peripheral device pairing management system as well as other computer-readable program code such as a correlating software agent (e.g., Dell® SupportAssist®) to pass the symmetric key 294-B onto the information handling system 200. Such a transfer may be managed by a backend management server in some embodiments or coordinated via manufacturer 276. The information handling system 200 may store the symmetric key in a secure memory location such as, for example, a unified extensible firmware interface (UEFI) memory location to secure the symmetric key 294-B until use. The present specification contemplates, therefore, that the wireless peripheral device manufacturer 276 may operate a backend management server 270 to provide this symmetric key 294-B to the information handling system 200 or may rely on a third party operating a backend management server 270 to do the same.

When the wireless peripheral device manufacturer 276 stores the symmetric keys 294-A on the wireless peripheral device 252, the wireless peripheral device manufacturer 276 may also store the PD ID 268 on a memory device of the wireless peripheral device 252. In an embodiment, the PD ID 268 may be a serial number assigned by the wireless peripheral device manufacturer 276 to the wireless peripheral device 252 that is unique to the wireless peripheral device 252. The uniqueness of the PD ID 268, therefore, is another layer of security such that execution of the systems and methods described herein, further prevents man-in-the-middle attacks.

Concurrently, the wireless peripheral device manufacturer 276 may ship the wireless peripheral device 252 to the user. Again, the wireless peripheral device 252 may include a memory device where the matching or complementary symmetric key 294-A is stored. When the user receives the wireless peripheral device 252, the user may activate or otherwise turn on the wireless peripheral device 252 to initiate the pairing process described herein.

The use of the symmetric keys 294-A, 294-B to transfer symmetrical key-wrapped pairing key data unwrapped and used to automatically discover, verify, and initialize BT pairing of the wireless peripheral device 252 to the information handling system 200 may include a number of example processes. In an example embodiment, as the wireless peripheral device 252 is activated by the user, the wireless peripheral device 252 may execute, with a hardware microcontroller or any other type of hardware processing device, a random number generator (RNG) algorithm 288. The RNG algorithm 288 may generate an OOB temporary key 266 with seed 298 and index 299 data, where the OOB temporary key may be used to automatically verify that the wireless peripheral device 252 is to be BT paired with the information handling system 200. In an example embodiment, as the wireless peripheral device 252 is activated by the user, the wireless peripheral device 252 may execute, with a hardware microcontroller or any other type of hardware processing device, the RNG algorithm 288. Execution of the RNG algorithm 288 by the hardware processor of the wireless peripheral device 252 causes the RNG algorithm 288 to use a seed 298 value and an index 299 value in a hash algorithm to generate the OOB temporary key 266.

In an embodiment, the wireless peripheral device 252 may encrypt a copy of the created OOB temporary key 266 and PD ID 268 using the symmetric key 294-A to create a symmetrical key-wrapped OOB temporary key and PD ID (e.g., 311, FIG. 3) that is the symmetrical key-wrapped pairing key data. This symmetrical key-wrapped OOB temporary key and PD ID is now securely wrapped by the symmetric key 294 known only by the wireless peripheral device 252 and information handling system 200 preventing any other person such as a man-in-the-middle entity from retrieving the OOB temporary key 266 and PD ID 268 even if the symmetrical key-wrapped OOB temporary key and PD ID is obtained.

At this point, the information handling system 200 receives the symmetrical key-wrapped OOB temporary key and PD ID and unwraps by executing computer-readable program code of a decryption agent 292 using the symmetric key 294-B that matches or complements the symmetric key 294-A of the wireless peripheral device 252. By unwrapping the symmetrical key-wrapped OOB temporary key and PD ID, the information handling system 200 retrieves its own copy of the OOB temporary key 266 and PD ID 268. The OOB temporary key 266 and PD ID 268, therefore, match the OOB temporary key 266 generated by the execution of the random number generator 288 by the wireless peripheral device 252 and the PD ID 268 stored on the memory device of the wireless peripheral device 252.

Upon unwrapping the OOB temporary key 266 and PD ID 268, the information handling system 200 may store the OOB temporary key 266 and PD ID 268 in a unified extensible firmware interface (UEFI) memory device 260 as UEFI variable data 262 or store the OOB temporary key 266 and PD ID 268 in other secure memory locations in various memory devices in various embodiments. The UEFI memory device 260 on the information handling system 200 may be any memory device that maintains the PD ID 268 and OOB temporary key 266 for later retrieval by an operating system (OS) Bluetooth® (BT) stack (e.g., 372, FIG. 3) under direction of a hardware processor in one embodiment. In an embodiment, the UEFI variable data 262 is stored on a flash memory device associated with the basic input/output system (BIOS).

In an embodiment, the OS BT stack includes computer executable program code with hardware that, when executed by a hardware processor (e.g., hardware processor, embedded controller, or any other hardware processing resource) along with code instructions of the automatic peripheral device pairing management system pairing agent 256 of the information handling system 200, performs automatic querying, verification, and initiation of BT pairing operations between the information handling system 200 and wireless peripheral device 252, and controls operations of a Bluetooth radio 230-2 under any BT protocols, among other functions. A plurality of protocols may be present in the Bluetooth stack which may include core protocols including Bluetooth radio, baseband, link manage protocol, logical link control and adaptation protocol, and service discovery protocols. Further, the protocols present with the Bluetooth stack include adopted protocols such as those protocols adopted from standard models (e.g., Point-to-Point Protocol, Internet Protocol, User Datagram Protocol, Transmission Control Protocol, and Wireless Application Protocol). Attention command sets may also be part of the protocols associated with the Bluetooth stack. Physical layers of the Bluetooth stack also include a radio (e.g., Bluetooth radio 230-2) used to transmit radio waves at a specific frequency as described herein. The frequency with which the Bluetooth stack of the Bluetooth radio 230-2 queries the UEFI variable data 262 to determine if OOB temporary key 266 and PD ID 268 data is available may vary. In an embodiment, the Bluetooth stack may query the UEFI memory device 260 for the UEFI variable data 262 during every power up of the information handling system 200. In an embodiment, the Bluetooth stack may query the UEFI variable data 262 on the UEFI memory device 260 a plurality of times when the information handling system 200 is powered up.

In an embodiment, the wireless peripheral device 252, after sending the symmetrical key-wrapped OOB temporary key and PD ID may reset. This resetting process may be a process that places the wireless peripheral device 252 in a state to broadcast the PD ID 268 to the information handling system 200 after a certain length of time to allow the information handling system 200 to conduct the unwrapping process described herein. In an embodiment, the wireless peripheral device 252 may not reset and, instead, may wait for a period of time before broadcasting the PD ID 268 so that the information handling system 200 may unwrap the symmetrical key-wrapped OOB temporary key and PD ID, store the OOB temporary key 266 and PD ID 268 on the UEFI memory device, and cause the OS BT stack to access the OOB temporary key 266 and PD ID 268.

When the wireless peripheral device 252 broadcasts the PD ID 268 in a pairing query, via an OOB BT broadcast, that broadcasting indicates the availability of the wireless peripheral device 252 to pair with the information handling system 200 to the information handling system 200. In an embodiment, this broadcast includes a pairing request to the information handling system 200 to BT pair with the wireless peripheral device 252. In the embodiments herein, the OS BT stack associated with the Bluetooth radio 230-2 may detect this PD ID 268 and, via execution of code instructions of the automatic peripheral device pairing management system pairing agent 256 of the information handling system 200, compare it to the PD ID 268 received from the unwrapping of the symmetrical key-wrapped OOB temporary key and PD ID and stored on the UEFI memory device. In an embodiment, the PD ID 268 stored in the UEFI memory device 260 and accessed by the OS BT stack may be one of a plurality of PD IDs 268 when, for example the user had purchased a plurality of wireless peripheral devices 286 and the symmetric key 294-B or a plurality of different symmetric keys 294-B were provided to the information handling system 200 for automatic querying, verification, and BT pairing with these plurality of ordered wireless peripheral devices 286.

Again, because the symmetrical key-wrapped OOB temporary key and PD ID was unwrapped by the information handling system 200 via execution of the decrypting agent 292, the PD ID 268 used to compare with the broadcasted PD ID 268 from the wireless peripheral device 252 is also correlated to a corresponding OOB temporary key 266 for the wireless peripheral device 252 identified as the querying wireless peripheral device 252. Where the PD ID 268 provided by the wireless peripheral device 252 does not match the PD ID 268 accessed by the Bluetooth stack of the Bluetooth radio 230-2, the pairing process is not completed. Where the broadcasted PD ID 268 provided by the wireless peripheral device 252 matches the PD ID 268 stored in the UEFI memory device 260, the automatic verification and initiation of BT pairing process may proceed via execution of code instructions of the automatic peripheral device pairing management system pairing agent 256.

In an embodiment, the Bluetooth stack of the Bluetooth radio 230-2 may request certain received signal strength indicator (RSSI) data signal (e.g., 335, FIG. 3) from the wireless peripheral device 252. RSSI data signal is received by the BT radio 230-2 of the information handling system 200 and the power level being received from the radio at the wireless peripheral device 252 (e.g., after calculated antenna and cable loss) can be determined. RSSI threshold data received by the wireless interface adapter of the information handling system 200 indicates whether, in an embodiment, the wireless peripheral device 252 is within a threshold range of the information handling system 200. In an embodiment where multiple wireless peripheral devices 286 are activated near the information handling system 200, the RSSI threshold may prevent other wireless peripheral devices 286 that are not within a threshold distance of the user's information handling system 200 from initiating automatic BT pairing. The RSSI power level provided by the wireless peripheral device 252 may be compared to an RSSI threshold value set at the Bluetooth radio 230-2 of the information handling system 200. Where the wireless peripheral device 252 RSSI value does not meet or exceed the RSSI threshold value, the information handling system 200 may ignore the pairing request of the wireless peripheral device 252. Where the RSSI value meets or exceeds the RSSI threshold value, the OS BT stack of the Bluetooth radio 230-2 within the information handling system 200 may continue the automatic verification and initiation of BT pairing process to establish a BT wireless link.

The automatic verification and initiation of the BT pairing process, in an embodiment, is executed by code instructions of the automatic peripheral device pairing management system pairing agent 256 of the information handling system 200 and includes the information handling system 200 verifying that the OOB temporary key 266 matches the OOB temporary key 266 stored at the wireless peripheral device 252 attempting to BT pair with the information handling system 200. This may be done with a process where the OOB temporary key 266 is used to encrypt a message or data sent to the wireless peripheral device 252 and the OOB temporary key 266 is used to decrypt the message and a message is encrypted and decrypted in the reverse between the wireless peripheral device 252 and the information handling system 200 as well. Such a process may execute a confirm value generation function in accordance with embodiments herein. With such encryption and decryption if the messages match, the OOB temporary key 266 and OOB temporary key 266 on the wireless peripheral device 252 may be verified as matching in one example embodiment. In an embodiment, the automatic verification and initiation of the BT pairing process may use a Bluetooth out-of-band (OOB), a legacy BLE GOB pairing, a Bluetooth Low Energy (BLE) GOB pairing protocol, or any other suitable protocol to verify and then to BT pair the wireless peripheral device 252 to the information handling system 200. In an embodiment, the information handling system 200 and wireless peripheral device 252 can each provide various automatic querying, verification, and BT pairing communications that includes the OOB temporary key 266 verification and a pairing response command via an OOB BT communication.

In an example embodiment, the information handling system 200 may encrypt an Mconfirm value from its copy of the OOB temporary key 266 via an encryption algorithm, provide encrypted Mconfirm to the wireless peripheral device 252, for decryption at the wireless peripheral device 252 its own stored copy of the OOB temporary key 266. Further, the decrypted Mconfirm value may be used as an Sconfirm value encrypted at the wireless peripheral device 252 and sent to the information handling system 200 for decryption using the GOB temporary key 266 to determine the sent Sconfirm value. A match of the received Sconfirm from the wireless peripheral device 252 with the Mconfirm from the information handling system 200 may be used as verification in such an example embodiment. Where the values match, the BT pairing process establishes a session key and a BT wireless link via the OS BT stack and BT protocols. Then the BT pairing process is completed between the wireless peripheral device 252 and information handling system 200. In an embodiment, once the wireless peripheral device 252 is paired with the information handling system 200, the OOB temporary key 266 is no longer used and the OOB temporary key 266 on both the information handling system 200 and the wireless peripheral device 252 may be deleted. Thus, in an embodiment, the OOB temporary key 266 may be a single use temporary key in some embodiments.

Again, the use of the symmetric keys 294-A, 294-B to automatically discover, verify, and initialize BT pairing of the wireless peripheral device 252 to the information handling system 200 may include another example processes. In an example embodiment, as the wireless peripheral device 252 is activated by the user, the wireless peripheral device 252 may execute, with a hardware microcontroller or any other type of hardware processing device, the RNG algorithm 288. Execution of the RNG algorithm 288 by the hardware processor of the wireless peripheral device 252 causes the RNG algorithm 288 to use a seed 298 value and an index 299 value in a hash algorithm to generate an OOB temporary key 266. The seed 298 value and index 299 value are used with the hash loop during the pairing processes to generate a copy of the OOB temporary key at both the wireless peripheral device 252 and the information handling system 200 as described herein. The seed 298 value may be used as an initialization vector to inform a hash loop algorithm where to start the hash loop algorithm and the index 299 value informs the hash loop algorithm the number of times to re-concatenate the hash loop algorithm for generating the OOB temporary key 266.

At this point the seed 298 and index 299 values are created, the OOB temporary key encryption agent 284 may encrypt the seed 298 value and the index 299 value using the symmetric key 294-A. This encryption of the index 299 value and index 299 value creates a symmetrical key-wrapped seed and index data package (e.g., 411, FIG. 4) that is the symmetrical key-wrapped pairing key data securely transferred to the information handling system 100 from the wireless peripheral device 252. This symmetrical key-wrapped seed and index data package may be broadcast to the information handling system 200 with a pairing query in an unsecured BT broadcast channel in an OOB BT communication.

At this point, the information handling system 200 receives the symmetrical key-wrapped seed and index data package and PD ID 268 and proceeds to unwrap the symmetrical key-wrapped seed and index data package by executing computer-readable program code of the decryption agent 292 using the symmetric key 294-B that matches or complements the symmetric key 294-A of the wireless peripheral device 286. By unwrapping the symmetrical key-wrapped seed and index data package, the information handling system 200 uses a version of the RNG algorithm 288 to generate its own copy of the OOB temporary key 266 from the seed 298 value and the index 299 value. At this point, the hardware processor, EC, or other hardware processor executes the computer-readable program code of RNG algorithm 288 to execute the same hash loop algorithm the wireless peripheral device 252 with the unwrapped seed 298 value and index 299 value. The execution of the hash loop algorithm creates a unique OOB temporary key 266. The OOB temporary key 266 and PD ID 268, therefore, match the GOB temporary key 266 generated by the execution of the random number generator 288 by the wireless peripheral device 252 and the PD ID 268 stored on the memory device of the wireless peripheral device 252.

Upon unwrapping the symmetrical key-wrapped seed and index data package and generating the OOB temporary key 266 via execution of the hash loop algorithm, the information handling system 200 may store the OOB temporary key 266 and PD ID 268 in the UEFI memory device 260 as UEFI variable data 262 or store the OOB temporary key 266 and PD ID 268 in other secure memory locations in various memory devices in various embodiments. The UEFI memory device 260 on the information handling system 200 may be any memory device that maintains the PD ID 268 and OOB temporary key 266 for later retrieval by an operating system (OS) Bluetooth® (BT) stack (e.g., 472, FIG. 4) under direction of a hardware processor in one embodiment. In an embodiment, the UEFI variable data 262 is stored on a flash memory device associated with the basic input/output system (BIOS) of the information handling system 200.

In an embodiment, the OS BT stack includes computer executable program code with hardware that, when executed by a hardware processor along with code instructions of the automatic peripheral device pairing management system pairing agent 256 of the information handling system 200, performs automatic querying, verification, and initiation of BT pairing operations between the information handling system 200 and wireless peripheral device 252, and controls operations of a Bluetooth radio 230-2 under any BT protocols, among other functions. A plurality of protocols may be present in the Bluetooth stack which may include core protocols including Bluetooth radio, baseband, link manage protocol, logical link control and adaptation protocol, and service discovery protocols. Further, the protocols present with the Bluetooth stack include adopted protocols such as those protocols adopted from standard models (e.g., Point-to-Point Protocol, Internet Protocol, User Datagram Protocol, Transmission Control Protocol, and Wireless Application Protocol). Attention command sets may also be part of the protocols associated with the Bluetooth stack. Physical layers of the Bluetooth stack also include a radio (e.g., Bluetooth radio 230-2) used to transmit radio waves at a specific frequency as described herein. The frequency with which the Bluetooth stack of the Bluetooth radio 230-2 queries the UEFI variable data 262 to determine if OOB temporary key 266 and PD ID 268 data is available may vary. In an embodiment, the Bluetooth stack may query the UEFI memory device 260 for the UEFI variable data 262 during every power up of the information handling system 200. In an embodiment, the Bluetooth stack may query the UEFI variable data 262 on the UEFI memory device 260 a plurality of times when the information handling system 200 is powered up.

In an embodiment, the wireless peripheral device 252, after sending the symmetrical key-wrapped pairing key data with the OOB temporary key, or seed and index data and PD ID, the wireless peripheral device 252 may broadcast the PD ID 268 to the information handling system 200 to continue with the pairing process. When the wireless peripheral device 252 broadcasts the PD ID 268, via an OOB BT broadcast, that broadcasting indicates the availability of the wireless peripheral device 252 to pair with the information handling system 200 to the information handling system 200. In an embodiment, this broadcast includes a pairing request to the information handling system 200 to BT pair with the wireless peripheral device 252. In the embodiments herein, the OS BT stack associated with the Bluetooth radio 230-2 may detect this PD ID 268 and, via execution of code instructions of the automatic peripheral device pairing management system pairing agent 256 of the information handling system 200, compare it to the PD ID 268 received from the unwrapping of the symmetrical key-wrapped pairing key data with the PD ID and stored on the UEFI memory device. In an embodiment, the PD ID 268 stored in the UEFI memory device 260 and accessed by the OS BT stack may be one of a plurality of PD IDs 268 when, for example the user had purchased a plurality of wireless peripheral devices 286 and the symmetric key 294-B or a plurality of different symmetric keys 294-B were provided to the information handling system 200 for automatic querying, verification, and BT pairing with these plurality of ordered wireless peripheral devices 286.

Again, because the symmetrical key-wrapped key pairing data was unwrapped to yield OOB temporary key 266 and PD ID 268 by the information handling system 200 via execution of the decrypting agent 292, the PD ID 268 used to compare with the broadcasted PD ID 268 from the wireless peripheral device 252 is also correlated to a corresponding OOB temporary key 266 for the wireless peripheral device 252 identified as the querying wireless peripheral device 252. Where the PD ID 268 provided by the wireless peripheral device 252 does not match the PD ID 268 accessed by the Bluetooth stack of the Bluetooth radio 230-2, the pairing process is not completed. Where the broadcasted PD ID 268 provided by the wireless peripheral device 252 matches the PD ID 268 stored in the UEFI memory device 260, the automatic verification and initiation of BT pairing process may proceed via execution of code instructions of the automatic peripheral device pairing management system pairing agent 256.

In an embodiment, the Bluetooth stack of the Bluetooth radio 230-2 may request certain received signal strength indicator (RSSI) data signal (e.g., 335, FIG. 3) from the wireless peripheral device 252. RSSI data signal is received by the BT radio 230-2 of the information handling system 200 and the power level being received from the radio at the wireless peripheral device 252 (e.g., after calculated antenna and cable loss) can be determined. RSSI threshold data received by the wireless interface adapter of the information handling system 200 indicates whether, in an embodiment, the wireless peripheral device 252 is within a threshold range of the information handling system 200. In an embodiment where multiple wireless peripheral devices 286 are activated near the information handling system 200, the RSSI threshold may prevent other wireless peripheral devices 286 that are not within a threshold distance of the user's information handling system 200 from initiating automatic BT pairing. The RSSI power level provided by the wireless peripheral device 252 may be compared to an RSSI threshold value set at the Bluetooth radio 230-2 of the information handling system 200. Where the wireless peripheral device 252 RSSI value does not meet or exceed the RSSI threshold value, the information handling system 200 may ignore the pairing request of the wireless peripheral device 252. Where the RSSI value meets or exceeds the RSSI threshold value, the OS BT stack of the Bluetooth radio 230-2 within the information handling system 200 may continue the automatic verification and initiation of BT pairing process to establish a BT wireless link.

The automatic verification and initiation of the BT pairing process, in an embodiment, is executed by code instructions of the automatic peripheral device pairing management system pairing agent 256 of the information handling system 200 and includes the information handling system 200 verifying that the OOB temporary key 266 matches the OOB temporary key 266 stored at the wireless peripheral device 252 attempting to BT pair with the information handling system 200. This may be done with a process where the OOB temporary key 266 is used to encrypt a message or data sent to the wireless peripheral device 252 and the OOB temporary key 266 is used to decrypt the message and a message is encrypted and decrypted in the reverse between the wireless peripheral device 252 and the information handling system 200 as well. With such encryption and decryption if the messages match, the OOB temporary key 266 and GOB temporary key 266 on the wireless peripheral device 252 may be verified as matching in one example embodiment. In an embodiment, the automatic verification and initiation of the BT pairing process may use a Bluetooth out-of-band (OOB), a legacy BLE GOB pairing, a Bluetooth Low Energy (BLE) GOB pairing protocol, or any other suitable protocol to verify and then to BT pair the wireless peripheral device 252 to the information handling system 200. In an embodiment, the information handling system 200 and wireless peripheral device 252 can each provide various automatic querying, verification, and BT pairing communications that includes the OOB temporary key 266 verification and a pairing response command via an OOB BT communication.

In an example embodiment, the information handling system 200 may encrypt an Mconfirm value from its copy of the OOB temporary key 266 via an encryption algorithm, provide encrypted Mconfirm to the wireless peripheral device 252, for decryption at the wireless peripheral device 252 its own stored copy of the OOB temporary key 266. Further, the decrypted Mconfirm value may be used as an Sconfirm value encrypted at the wireless peripheral device 252 and sent to the information handling system 200 for decryption using the GOB temporary key 266 to determine the sent Sconfirm value. A match of the received Sconfirm from the wireless peripheral device 252 with the Mconfirm from the information handling system 200 may be used as verification in such an example embodiment. Where the values match, the BT pairing process establishes a session key and a BT wireless link via the OS BT stack and BT protocols. Then the BT pairing process is completed between the wireless peripheral device 252 and information handling system 200. In an embodiment, once the wireless peripheral device 252 is paired with the information handling system 200, the OOB temporary key 266 is no longer used and the OOB temporary key 266 on both the information handling system 200 and the wireless peripheral device 252 may be deleted. Thus, in an embodiment, the OOB temporary key 266 may be a single use temporary key in some embodiments.

The systems and methods described herein allows for a secure method of BT pairing a wireless peripheral device 252. The method allows an information handling system 200 to receive one of a symmetrical key-wrapped OOB temporary key and PD ID or symmetrical key-wrapped seed and index data package and a PD ID 268 that is to be unwrapped and used to create or simply expose an OOB temporary key 266 at both the information handling system 200 and wireless peripheral device 252. These corresponding OOB temporary keys 266 are to be matched so that a BT pairing request may be initiated and completed automatically. As such the resulting OOB temporary key 266 are secured and controlled by the symmetric keys 294-A and 294-B until the wireless peripheral device 252 broadcasts the symmetrical key-wrapped OOB temporary key and PD ID or symmetrical key-wrapped seed and index data package as described herein. This allows the wireless peripheral device manufacturer 276, a backend management server 270, and a wireless peripheral device 252 to secure the data used to BT pair the wireless peripheral device 252 to the information handling system 200 and limit exposure of OOB temporary keys to times when the verification and BT pairing process has initiated.

The systems and methods described herein also provide for a backend management server 270 executing a PD assignment agent 280 via a hardware processing resource or a wireless peripheral device manufacturer 276 to assign a wireless peripheral device 252 or even a plurality of wireless peripheral devices 286 to an specific information handling system 200 by controlling which information handling system 200 will be given the symmetric key 294-B that matches a symmetrical key 294-A on the wireless peripheral device 252 in some embodiments.

FIG. 3 is a process flow diagram of a method 301 of automatically querying, verifying, and BT pairing a wireless peripheral device 353 to an information handling system 300 using symmetrical keys 394 from a wireless peripheral device manufacturer 376 according to an embodiment of the present disclosure. As described herein, the wireless peripheral device manufacturer 376 shown in FIG. 3 may be the entity that stores a symmetric key 394 on a storage device of the wireless peripheral device 352 (e.g., a wireless mouse in the example embodiment of FIG. 3) at line 302. Additionally, via a network connection, a symmetric key 394 may be sent to the information handling system 300 at line 304. As described herein, the symmetric key 394 on both the wireless peripheral device 352 and the information handling system 300 may match or complement each other so that the information handling system 300 may automatically discover, verify, and initialize BT pairing with the wireless peripheral device 352 with a PD ID the OOB temporary key securely transferred and generated according to various embodiments herein. The information handling system 300 may then engage in a pairing query for automatic verification, and initiation of BT pairing to pair with the assigned wireless peripheral device 352 via execution of the automatic PD pairing management system pairing agent 356 with an OS BT stack as described herein.

It is appreciated that the symmetric keys 394 are matched or complementary symmetric key 394 that allow the information handling system 300 to automatically discover, verify, and initialize a BT pairing with the wireless peripheral device 352. The symmetric keys 394, therefore, are unique to the information handling system 300 and wireless peripheral device 352 such that only the wireless peripheral device 352 that includes a symmetric key 394 that matches or complements the symmetric key 394 provided to the information handling system 300 may be BT paired with the information handling system 300. This prevents the wireless peripheral device 352 from being BT paired with another information handling system 300 used by a user who did not purchase the wireless peripheral device 352 or is otherwise not allowed to use the wireless peripheral device 352 with their information handling system 300. Additionally, as described herein, the systems and methods used to automatically discover, verify, and initialize BT pairing of the wireless peripheral device 352 with the information handling system 300 prevent man-in-the-middle attacks from occurring by secretly securing the symmetric keys 394 in secure memory device locations such that no access can be gained by other devices or entities. Still further, the development of pairing OOB temporary keys 366 by the wireless peripheral device 352 and secure transfer of a copy to the information handling system 300 during the pairing process using the symmetric keys 394 limits the exposure of temporary key data to only after initiation of verification for the BT pairing process which temporally limits the exposure of this secure data.

Turning to the example shown in FIG. 3, a user may engage in purchasing a wireless peripheral device 352 via a wireless peripheral device manufacturer's 376 website or other purchasing means. As this occurs, the wireless peripheral device manufacturer 376 may be provided with certain purchasing data from the user. This purchasing data may include, in some example embodiments, a street address of the purchaser, a name of the purchaser, a unique customer number, or any other identification data that allows the wireless peripheral device manufacturer 376 to deliver the wireless peripheral device 352 to the user.

Concurrently, the wireless peripheral device manufacturer 376 may be provided with access to the user's information handling system 300 via a network connection, for example, in order to send the information handling system 300 a symmetric key 394 for later automatic discovery, verification, and initialization of the BT pairing processes described herein. This symmetric key 394 may match or complement a symmetric key 394 stored securely on a memory device of the wireless peripheral device 352, at line 302, by the wireless peripheral device manufacturer 376. In an embodiment, the wireless peripheral device manufacturer 376 may use an information handling system 300 such as the backend management server 370 that executes computer readable program code of the automatic peripheral device pairing management system as well as other computer-readable program code such as a correlating software agent (e.g., Dell® SupportAssist®) to pass the symmetric key 394 onto the information handling system 300 at line 304. The information handling system 300 may store the symmetric key 394 in a secure memory location such as, for example, a unified extensible firmware interface (UEFI) memory location to secure the symmetric key 394 until use. The present specification contemplates, therefore, that the wireless peripheral device manufacturer 376 or a system management provider such as a manufacturer of the information handling system 300 may operate a backend management server (e.g., 170, FIG. 1) to provide this symmetric key 394 to the information handling system 300 or may rely on a third party operating a backend management server to do the same.

When the wireless peripheral device manufacturer 376 stores the symmetric keys 394 on the wireless peripheral device 352, the wireless peripheral device manufacturer 376 may also store the PD ID 368 on a memory device of the wireless peripheral device 352 at line 302. In an embodiment, the PD ID 368 may be a serial number assigned by the wireless peripheral device manufacturer 376 to the wireless peripheral device 352 that is unique to the wireless peripheral device 352. The uniqueness of the PD ID 368, therefore, is another layer of security such that execution of the systems and methods described herein, further prevents man-in-the-middle attacks.

Concurrently, the wireless peripheral device manufacturer 376 may ship the wireless peripheral device 352 to the user at line 306. Again, the wireless peripheral device 352 may include a memory device where the matching or complementary symmetric key 394 is stored. When the user receives the wireless peripheral device 352, the user may activate or otherwise turn on the wireless peripheral device 352 to initiate the pairing process described herein at line 308.

In an embodiment, as the wireless peripheral device 352 is activated by the user at line 308, the wireless peripheral device 352 may execute, with a hardware microcontroller or any other type of hardware processing device, a random number generator (RNG) algorithm 388 at line 310. The RNG algorithm 388 may generate an out-of-band (OOB) temporary key 366 used to automatically verify that the wireless peripheral device 352 is to be BT paired with the information handling system 300. The RNG algorithm 388 may be a hash function algorithm that uses seed data and index data in the hash function to generate the OOB temporary key 366 used in the embodiments herein.

In an embodiment, at line 312, the wireless peripheral device 452 may encrypt the created OOB temporary key 366 and PD ID 368 using the symmetric key 394 to create a symmetrical key-wrapped OOB temporary key and PD ID 311 that is the symmetrical key-wrapped pairing key data in the present embodiment. This symmetrical key-wrapped OOB temporary key and PD ID 311 is now securely wrapped by the symmetric key 394 known only by the wireless peripheral device 352 and information handling system 300 preventing any other person such as a man-in-the-middle entity from retrieving the OOB temporary key 366 and PD ID 368 even if the symmetrical key-wrapped OOB temporary key and PD ID 311 is obtained during transmission at line 314.

At this point, the information handling system 300 receives the symmetrical key-wrapped OOB temporary key and PD ID 311 and, at line 316, unwraps by executing computer-readable program code of a decryption agent using the symmetric key 394 that matches or complements the symmetric key 394 of the wireless peripheral device 352. By unwrapping the symmetrical key-wrapped OOB temporary key and PD ID 311, the information handling system 300 retrieves its own copy of the OOB temporary key 366 and PD ID 368. The OOB temporary key 366 and PD ID 368, therefore, match the OOB temporary key 366 generated by the execution of the random number generator 388 by the wireless peripheral device 352 and the PD ID 368 stored on the memory device of the wireless peripheral device 352.

Upon unwrapping the OOB temporary key 366 and PD ID 368, the information handling system 300 may store, at line 318, the OOB temporary key 366 and PD ID 368 in a unified extensible firmware interface (UEFI) memory device as UEFI variable data or store the GOB temporary key 366 and PD ID 368 in other secure memory locations in various memory devices in various embodiments. The UEFI memory device on the information handling system 300 may be any memory device that maintains the PD ID 368 and OOB temporary key 366 for later retrieval by an OS BT stack 372 under direction of a hardware processor in one embodiment. In an embodiment, the UEFI variable data 362 is stored on a flash memory device associated with the basic input/output system (BIOS).

In an embodiment, the OS BT stack 372 includes computer executable program code with hardware that, when executed by a hardware processor (e.g., hardware processor, embedded controller, or any other hardware processing resource) along with code instructions of the automatic peripheral device pairing management system pairing agent of the information handling system 300, performs automatic querying, verification, and initiation of BT pairing operations between the information handling system 300 and wireless peripheral device 352, and controls operations of a Bluetooth radio under any BT protocols, among other functions. A plurality of protocols may be present in the Bluetooth stack which may include core protocols including Bluetooth radio, baseband, link manage protocol, logical link control and adaptation protocol, and service discovery protocols. Further, the protocols present with the Bluetooth stack include adopted protocols such as those protocols adopted from standard models (e.g., Point-to-Point Protocol, Internet Protocol, User Datagram Protocol, Transmission Control Protocol, and Wireless Application Protocol). Attention command sets may also be part of the protocols associated with the Bluetooth stack. Physical layers of the Bluetooth stack also include a radio (e.g., Bluetooth radio) used to transmit radio waves at a specific frequency as described herein. In an embodiment, the OS BT stack 372 may read UEFI variable data at line 320 in order to determine if the OOB temporary key 366 and PD ID 368 are present on the UEFI variable memory device 360. At line 322, the UEFI variable memory device 360 may send a response that the OOB temporary key 366 and PD ID 368 are available. At line 324, the OS BT stack 372 reads the UEFI variable data again to cause the UEFI variable memory device 360 to return the OOB temporary key 366 and PD ID 368 in an embodiment. In an embodiment, the UEFI variable memory device may also, at line 326 return an RSSI threshold data indicative of an RSSI threshold level 335 that is to be detected by the information handling system 300 before the information handling system 300 can be paired with the wireless peripheral device 352. The frequency with which the Bluetooth stack of the Bluetooth radio queries the UEFI variable data to determine if OOB temporary key 366 and PD ID 368 data is available may vary. In an embodiment, the Bluetooth stack may query the UEFI memory device for the UEFI variable data during every power up of the information handling system 300. In an embodiment, the Bluetooth stack may query the UEFI variable data on the UEFI memory device a plurality of times when the information handling system 300 is powered up.

At line 312, the wireless peripheral device 352, after sending the symmetrical key-wrapped OOB temporary key and PD ID may reset. This resetting process may be a process that places the wireless peripheral device 352 in a state to broadcast the PD ID 368 to the information handling system 300 after a certain length of time to allow the information handling system 300 to conduct the unwrapping process described herein. In an embodiment, the wireless peripheral device 352 may not reset and, instead, may wait for a period of time before broadcasting the PD ID 368 so that the information handling system 300 may unwrap the symmetrical key-wrapped GOB temporary key and PD ID 311, store the OOB temporary key 366 and PD ID 368 on the UEFI memory device, and cause the OS BT stack 372 to access the OOB temporary key 366 and PD ID 368.

When the wireless peripheral device 352 broadcasts the PD ID 368 in a pairing query at line 312, via an OOB BT broadcast, that broadcasting indicates the availability of the wireless peripheral device 352 to pair with the information handling system 300 to the information handling system 300. In an embodiment, this broadcast includes a pairing request to the information handling system 300 to BT pair with the wireless peripheral device 352. In the embodiments herein, the OS BT stack 372 associated with the Bluetooth radio may detect this PD ID 368 and, via execution of code instructions of the automatic peripheral device pairing management system pairing agent of the information handling system 300, compare it to the PD ID 368 received from the unwrapping of the symmetrical key-wrapped OOB temporary key and PD ID 311 and stored on the UEFI memory device. In an embodiment, the PD ID 368 stored in the UEFI variable memory device 360 and accessed by the OS BT stack 372 may be one of a plurality of PD IDs 368 when, for example the user had purchased a plurality of wireless peripheral devices 386 and the symmetric key 394 or a plurality of different symmetric keys 394 were provided to the information handling system 300 for automatic querying, verification, and BT pairing with these plurality of ordered wireless peripheral devices 386.

Again, because the symmetrical key-wrapped OOB temporary key and PD ID 311 was unwrapped by the information handling system 300 via execution of the decrypting agent, the PD ID 368 used to compare with the broadcasted PD ID 368 broadcast from the wireless peripheral device 352 is also correlated to a corresponding OOB temporary key 366 at the information handling system 300 and identifies the wireless peripheral device 352 as the querying wireless peripheral device 352. Where the PD ID 368 provided by the wireless peripheral device 352 does not match the PD ID 368 accessed by the OS BT stack 372 of the Bluetooth radio at line 328, the pairing process is not completed. Where it is determined at line 328 the broadcasted PD ID 368 provided by the wireless peripheral device 352 matches the PD ID 368 stored in the UEFI memory device 360, the automatic verification and initiation of BT pairing process may proceed via execution of code instructions of the automatic peripheral device pairing management system pairing agent.

In an embodiment, the OS BT stack 372 of the Bluetooth radio may request an RSSI data signal from the wireless peripheral device 352 at line 330. RSSI data signal is received, at line 332, by the BT radio of the information handling system 300 and the power level being received from the radio at the wireless peripheral device 352 (e.g., after calculated antenna and cable loss) can be determined. RSSI threshold data received by the wireless interface adapter of the information handling system 300 indicates whether, in an embodiment, the wireless peripheral device 352 is within a threshold range of the information handling system 300. In an embodiment where multiple wireless peripheral devices 386 are activated near the information handling system 300, the RSSI threshold 335 may prevent other wireless peripheral devices 386 that are not within a threshold distance of the user's information handling system 300 or at a threshold RSSI level from initiating automatic BT pairing. The RSSI power level provided by the wireless peripheral device 352 may be compared to an RSSI threshold value 335 received at line 326 from the UEFI variable memory device 360 and set at the Bluetooth radio of the information handling system 300. Where the wireless peripheral device 352 RSSI value does not meet or exceed the RSSI threshold value 335 at line 334, the information handling system 300 may ignore the pairing request of the wireless peripheral device 352. Where the RSSI value meets or exceeds the RSSI threshold value 335 at line 334, the OS BT stack of the Bluetooth radio within the information handling system 300 may continue the automatic verification and initiation of BT pairing process to establish a BT wireless link.

The automatic verification and initiation of the BT pairing process, in an embodiment, is executed by code instructions of the automatic peripheral device pairing management system pairing agent 356 of the information handling system 300 and includes the information handling system 300 verifying that the OOB temporary key 366 matches the OOB temporary key 366 stored at the wireless peripheral device 352 attempting to BT pair with the information handling system 300 via a parallel confirm value generation function and exchange of values via encryption at lines 336, 338, and 340. This may be done with a process where the OOB temporary key 366 is used to encrypt a message or data sent to the wireless peripheral device 352 at line 336 and the OOB temporary key 366 is used to decrypt the message and a message is encrypted and decrypted in the reverse between the wireless peripheral device 352 and the information handling system 300 as well. With such encryption and decryption of the compare values in the messages match, the OOB temporary key 366 and OOB temporary key 366 on the wireless peripheral device 352 may be verified as matching in one example embodiment. In an embodiment, the automatic verification and initiation of the BT pairing process may use a Bluetooth out-of-band (OOB), a legacy BLE GOB pairing, a Bluetooth Low Energy (BLE) GOB pairing protocol, or any other suitable protocol to verify and then to BT pair the wireless peripheral device 352 to the information handling system 300. In an embodiment, the information handling system 300 and wireless peripheral device 352 can each provide various automatic querying, verification, and BT pairing communications that includes the OOB temporary key 366 verification and a pairing response command via an OOB BT communication.

In a particular example embodiment, the information handling system 300 may generate and encrypt an Mconfirm value from its copy of the OOB temporary key 366 via an encryption algorithm, and provide the encrypted Mconfirm to the wireless peripheral device 352 at line 336. The Mconfirm value may be decrypted at the wireless peripheral device 352 against its own stored copy of the OOB temporary key 366. Further, the decrypted Mconfirm value may be used for comparison there to a generated Sconfirm value at the wireless peripheral device 352 at line 340. The wireless peripheral device also encrypts the Sconfirm value and sends it to the information handling system 300 also at 336 for decryption using the OOB temporary key 366 at the information handling system 300 to determine the sent Sconfirm value at line 338. A match of the received Sconfirm from the wireless peripheral device 352 with the Mconfirm from the information handling system 300 at lines 338 and 340 may be used as verification that the OOB temporary keys 366 match in such an example embodiment. Where the values match, the BT pairing process establishes a session key and a BT wireless link via the OS BT stack and BT protocols at line 342. Then the BT pairing process is completed between the wireless peripheral device 352 and information handling system 300.

In one embodiment, once the wireless peripheral device 352 is paired with the information handling system 300, the OOB temporary key 366 is no longer used and the OOB temporary key 366 on both the information handling system 300 and the wireless peripheral device 352 may be deleted at line 342. Thus, in an embodiment, the OOB temporary key 366 may be a single use temporary key in some embodiments so that it is ephemeral.

FIG. 4 is a process flow diagram of a method 401 of automatically querying, verifying, and Bluetooth® pairing a wireless peripheral device to an information handling system 400 using symmetrical keys 494 from a wireless peripheral device manufacturer 476 according to another embodiment of the present disclosure. As described herein, the wireless peripheral device manufacturer 476 shown in FIG. 4 may be the entity that stores a symmetric key 494 on a storage device of the wireless peripheral device 452 (e.g., a wireless mouse in the example embodiment of FIG. 4) at line 402. Additionally, via a network connection, a symmetric key 494 may be sent to the information handling system 400 at line 404. As described herein, the symmetric key 494 on both the wireless peripheral device 452 and the information handling system 400 may match or complement each other so that the information handling system 400 may automatically discover, verify, and initialize BT pairing with the wireless peripheral device 452 using the PD ID 468 and the OOB temporary key 466 matches according to embodiments herein. The information handling system 400 may then engage in a pairing query for automatic verification, and initiation of BT pairing to pair with the assigned wireless peripheral device 452 via execution of the automatic PD pairing management system pairing agent with an OS BT stack 472 as described herein.

It is appreciated that the symmetric keys 494 are matched or complementary symmetric key 494 that allow the information handling system 400 to automatically discover, verify, and initialize a BT pairing with the wireless peripheral device 452. The symmetric keys 494, therefore, are unique to the information handling system 400 and wireless peripheral device 452 such that only the wireless peripheral device 452 that includes a symmetric key 494 that matches or complements the symmetric key 494 provided to the information handling system 400 may be BT paired with the information handling system 400. This prevents the wireless peripheral device 452 from being BT paired with another information handling system 400 used by a user who did not purchase the wireless peripheral device 452 or is otherwise not allowed to use the wireless peripheral device 452 with their information handling system 400. Additionally, as described herein, the systems and methods used to automatically discover, verify, and initialize BT pairing of the wireless peripheral device 452 with the information handling system 400 using matching OOB temporary keys 466 securely transferred with the symmetric keys 494 upon pairing initiation to prevent man-in-the-middle attacks from occurring. Further, by secretly securing the symmetric keys 494 in secure memory device locations such that no access can be gained by other devices or entities an additional layer of security is provided. Still further, the development of pairing OOB temporary keys 466 by each of the wireless peripheral device 452 and information handling system 400 during the pairing process using the symmetric keys 494 limits the exposure of temporary key data to only during an initial verification step of the BT pairing process and deleting the same upon pairing, thus temporally limiting the exposure of this secure data.

Turning to the example shown in FIG. 4, a user may engage in purchasing a wireless peripheral device 452 via a wireless peripheral device manufacturer's 476 website or other purchasing means. As this occurs, the wireless peripheral device manufacturer 476 may be provided with certain purchasing data from the user. This purchasing data may include, in some example embodiments, a street address of the purchaser, a name of the purchaser, a unique customer number, or any other identification data that allows the wireless peripheral device manufacturer 476 to deliver the wireless peripheral device 452 to the user.

Concurrently, the wireless peripheral device manufacturer 476 may be provided with access to the user's information handling system 400 via a network 446 connection, for example, in order to send the information handling system 400 a symmetric key 494 for later automatic discovery, verification, and initialization of the BT pairing processes described herein. This symmetric key 494 may match or complement a symmetric key 494 stored securely on a memory device of the wireless peripheral device 452, at line 402, by the wireless peripheral device manufacturer 476. In an embodiment, the wireless peripheral device manufacturer 476 may use an information handling system 400 such as the backend management server 470 that executes computer readable program code of the automatic peripheral device pairing management system as well as other computer-readable program code such as a correlating software agent (e.g., Dell® SupportAssist®) to pass the symmetric key 494 onto the information handling system 400 at line 404. The information handling system 400 may store the symmetric key 494 in a secure memory location such as, for example, a UEFI memory location on the UEFI variable memory device 460 to secure the symmetric key 494 until use. The present specification contemplates, therefore, that the wireless peripheral device manufacturer 476, an information handling system manufacturer or system management service provider may operate a backend management server (e.g., 170, FIG. 1) to provide this symmetric key 494 to the information handling system 400, or the embodiments herein may rely on a third party operating a backend management server to do the same.

When the wireless peripheral device manufacturer 476 stores the symmetric keys 494 on the wireless peripheral device 452, the wireless peripheral device manufacturer 476 may also store the PD ID 468 on a memory device of the wireless peripheral device 452 at line 402. In an embodiment, the PD ID 468 may be a serial number assigned by the wireless peripheral device manufacturer 476 to the wireless peripheral device 452 that is unique to the wireless peripheral device 452. The uniqueness of the PD ID 468, therefore, is another layer of security such that execution of the systems and methods described herein, further prevents man-in-the-middle attacks.

Concurrently, the wireless peripheral device manufacturer 476 may ship the wireless peripheral device 452 to the user at line 406. Again, the wireless peripheral device 452 may include a memory device where the matching or complementary symmetric key 494 is stored. When the user receives the wireless peripheral device 452, the user may activate or otherwise turn on the wireless peripheral device 452 to initiate the pairing process described herein at line 408.

In the embodiment shown in FIG. 4, as the wireless peripheral device 452 is activated by the user at line 408, the wireless peripheral device 452 may execute, with a hardware microcontroller or any other type of hardware processing device, the RNG algorithm at line 410. Execution of the RNG algorithm by the hardware processor of the wireless peripheral device 452 at line 410 causes the RNG algorithm using a seed 498 value and an index 499 value provided by the manufacturer 401 or a backend management server in some embodiments. One or both of the seed 498 value and index 499 value may be unique to the wireless peripheral device 452, the user, the information handling system 300, the manufacturer, or from another source. The seed 498 value and index 499 value are used along with a hash loop algorithm of a RNG algorithm as discussed above during the pairing processes described herein to generate a OOB temporary key 466 at both the wireless peripheral device 452 at line 430 and the information handling system 400 at line 418 after secure transmission to the information handling system 400. The seed 498 value may be used as an initialization vector to inform a hash loop algorithm of the RNG algorithm indicating where to start the hash loop algorithm and the index 499 value informs the hash loop algorithm the number of times to re-concatenate the hash loop algorithm. The hash loop algorithm described herein may include hash loop algorithms such as Secure Hash Algorithm (SHA)-256, SHA 2, SHA-3 among others.

At this point the seed 498 and index 499 values are created at line 410, the OOB temporary key encryption agent may encrypt the seed 498 value and the index 499 value using the symmetric key 494 at line 412. This encryption of the index 499 value and index 499 value creates a symmetrical key-wrapped seed and index data package 411. This symmetrical key-wrapped seed and index data package 411 may then be transmitted to the information handling system 400 at line 414. At this point, the information handling system 400 receives the symmetrical key-wrapped seed and index data package 411 and PD ID 468 and proceeds to unwrap, at line 416, the symmetrical key-wrapped seed and index data package 411 by executing computer-readable program code of the decryption agent using the symmetric key 494 that matches or complements the symmetric key 494 of the wireless peripheral device 452. By unwrapping the symmetrical key-wrapped seed and index data package 411 at line 416, the information handling system 400 retrieves its own copy of the seed 498 value and the index 499 value.

At line 418, the hardware processor, EC, or other hardware processor executes the computer-readable program code of the RNG algorithm to execute the same hash loop algorithm the wireless peripheral device 452 used to create a copy of the OOB temporary key 466 from the seed 498 value and index 499 value at the information handling system 400. It is appreciated that the hash algorithm described herein includes a number of properties that add security to the systems and methods described herein. For example, the hash loop algorithm may reduce power consumption at a hardware processor (e.g., EC) and be capable of implementing a digital signature link between the created OOB temporary key 466 and the PD ID 468. The irreversible one-way derivation function of the hash algorithm adds further security to the systems and methods 401 (e.g., seed provisioning into the hash loop algorithm creates the OOB temporary key 466 which is further related to the PD ID 468). This prevents the creation of the OOB temporary key 466 even if the PD ID 468 is known as well as the creation of the seed 498 even if the OOB temporary key 466 is known. The hash loop algorithm may include combinations of a plurality of hash loop functions such as SHA-256, SHA-2, SHA-3 as well as other symmetrical encryption algorithms such as AES-256 (Advanced Encryption Standard-256) among others.

The execution of the hash loop algorithm creates a unique OOB temporary key 466 associated with the received and unwrapped PD ID 468 in memory 460 at the information handling system 400. The OOB temporary key 466 and PD ID 468, therefore, match the OOB temporary key 466 generated by the execution of a hash loop algorithm by the wireless peripheral device 452 described herein and the PD ID 468 stored on the memory device of the wireless peripheral device 452.

Upon unwrapping the symmetrical key-wrapped seed and index data package 411 including the PD ID 468 and generating the OOB temporary key 466 via execution of the hash loop algorithm at line 418, the information handling system 400 may store the OOB temporary key 466 and PD ID 468 in the UEFI memory device 460 as UEFI variable data as shown or store the OOB temporary key 466 and PD ID 468 in other secure memory locations of another memory device in various embodiments at line 420. The UEFI memory device 460 on the information handling system 400 may be any memory device that maintains the PD ID 468 and GOB temporary key 466 for later retrieval by an operating system (OS) Bluetooth® (BT) stack under direction of a hardware processor (e.g., hardware processor 402) in one embodiment. In an embodiment, the UEFI variable data is stored on a flash memory device associated with the basic input/output system (BIOS) of the information handling system 400.

In an embodiment, the OS BT stack 472 includes computer executable program code with hardware that, when executed by a hardware processor (e.g., hardware processor, embedded controller, or any other hardware processing resource) along with code instructions of the automatic peripheral device pairing management system pairing agent of the information handling system 400, performs automatic querying, verification, and initiation of BT pairing operations between the information handling system 400 and wireless peripheral device 452, and controls operations of a Bluetooth radio under any BT protocols, among other functions. A plurality of protocols may be present in the Bluetooth stack which may include core protocols including Bluetooth radio, baseband, link manage protocol, logical link control and adaptation protocol, and service discovery protocols. Further, the protocols present with the Bluetooth stack include adopted protocols such as those protocols adopted from standard models (e.g., Point-to-Point Protocol, Internet Protocol, User Datagram Protocol, Transmission Control Protocol, and Wireless Application Protocol). Attention command sets may also be part of the protocols associated with the Bluetooth stack. Physical layers of the Bluetooth stack also include a radio (e.g., Bluetooth radio) used to transmit radio waves at a specific frequency as described herein. In an embodiment, the OS BT stack 472 may read UEFI variable data at line 422 in order to determine if the OOB temporary key 466 and PD ID 468 are present on the UEFI variable memory device 460. At line 424, the UEFI variable memory device 460 may send a response that the OOB temporary key 466 and PD ID 468 are available. At line 426, the OS BT stack 472 reads the UEFI variable data again to cause the UEFI variable memory device 460 to return the OOB temporary key 466 and PD ID 468 in an embodiment. In an embodiment, the UEFI variable memory device may also, at line 428, return an RSSI threshold data 435 indicative of an RSSI threshold level 435 that is to be detected by the information handling system 400 before the information handling system 400 can be paired with the wireless peripheral device 452. The frequency with which the Bluetooth stack of the Bluetooth radio queries the UEFI variable data to determine if OOB temporary key 466 and PD ID 468 data is available may vary. In an embodiment, the Bluetooth stack may query the UEFI variable memory device 460 for the UEFI variable data during every power up of the information handling system 400. In an embodiment, the Bluetooth stack may query the UEFI variable data on the UEFI memory device a plurality of times when the information handling system 400 is powered up.

At line 430, the wireless peripheral device 452, has also used the hash loop algorithm along with the seed 498 value and index 499 value to generate the same OOB temporary key 466 as that generated at the information handling system 400. Because the seed 498 value, index 499 value, and hash loop algorithm are the same at the information handling system 400 and the wireless peripheral device 452, the same OOB temporary key 466 is created for use by the wireless peripheral device 452 and information handling system 400 to verify BT pairing. At line 432, the wireless peripheral device 452 may broadcast the PD ID 468 as part of a pairing query under any BT standard to the information handling system 400 to initiate the pairing process.

When the wireless peripheral device 452 broadcasts the PD ID 468 in a pairing query, via an OOB BT broadcast, that broadcasting indicates the availability of the wireless peripheral device 452 to pair with the information handling system 400 to the information handling system 400. In an embodiment, this broadcast includes a pairing request to the information handling system 400 to BT pair with the wireless peripheral device 452. At line 434, the OS BT stack associated with the Bluetooth radio may detect this PD ID 468 and, via execution of code instructions of the automatic peripheral device pairing management system pairing agent of the information handling system 400, compare it to the PD ID 468 received from the unwrapping of the symmetrical key-wrapped seed and index data package 411 that included the PD ID 468 and stored it on the UEFI memory device. In an embodiment, the PD ID 468 stored in the UEFI memory device 460 and accessed by the OS BT stack 472 may be one of a plurality of PD IDs 468 when, for example the user had purchased a plurality of wireless peripheral devices 452 and the symmetric key 494 or a plurality of different symmetric keys 494 were provided to the information handling system 400 for automatic querying, verification, and BT pairing with these plurality of ordered wireless peripheral devices 452.

Again, because the symmetrical key-wrapped seed and index data package was unwrapped by the information handling system 400 via execution of the decrypting agent, the PD ID 468 used to compare, at line 434, with the broadcasted PD ID 468 from the wireless peripheral device 452 is also correlated to a corresponding OOB temporary key 466 at the information handling system 400 and associated with the wireless peripheral device 452 identified as the querying wireless peripheral device 452. Where the PD ID 468 provided by the wireless peripheral device 452 does not match the PD ID 468 accessed by the Bluetooth stack of the Bluetooth radio at line 434, the pairing process is not completed. Where, at line 434, the broadcasted PD ID 468 provided by the wireless peripheral device 452 matches the PD ID 468 stored in the UEFI memory device 460, the automatic verification and initiation of BT pairing process may proceed via execution of code instructions of the automatic peripheral device pairing management system pairing agent.

In an embodiment, the OS BT stack 472 of the Bluetooth radio may request certain RSSI data signal from the wireless peripheral device 452 at line 436. RSSI data signal is received at line 438 by the BT radio of the information handling system 400 and the power level being received from the radio at the wireless peripheral device 452 (e.g., after calculated antenna and cable loss) can be determined. RSSI threshold data 435 received by the wireless interface adapter at line 428 of the information handling system 400 indicates whether, in an embodiment, the wireless peripheral device 452 is within a threshold range of the information handling system 400. In an embodiment where multiple wireless peripheral devices 452 are activated near the information handling system 400, the RSSI threshold 435 may prevent other wireless peripheral devices 452 that are not within a threshold distance of the user's information handling system 400 from initiating automatic BT pairing. The RSSI power level provided by the wireless peripheral device 452 may be compared, at line 440, to an RSSI threshold value 435 set at the Bluetooth radio of the information handling system 400. Where the wireless peripheral device 452 RSSI value does not meet or exceed the RSSI threshold value 435 at line 440, the information handling system 400 may ignore the pairing request of the wireless peripheral device 452. Where the RSSI value meets or exceeds the RSSI threshold value 435 at line 440, the OS BT stack 472 of the Bluetooth radio within the information handling system 400 may continue the automatic verification and initiation of BT pairing process to establish a BT wireless link.

The automatic verification and initiation of the BT pairing process, in an embodiment, is executed by code instructions of the automatic peripheral device pairing management system pairing agent of the information handling system 400 and includes, at lines 442, 444, and 446, the information handling system 400 verifying that the OOB temporary key 466 matches the OOB temporary key 466 stored at the wireless peripheral device 452 attempting to BT pair with the information handling system 400 such as with a confirm value generation function and exchange of encrypted message values that may be decrypted with the corresponding OOB temporary keys 466 on each side of the pairing. This may be done with a process where the GOB temporary key 466 is used to encrypt a message or data for a confirm value sent to the wireless peripheral device 452 at line 442. The OOB temporary key 466 at the wireless peripheral device 452 is used to decrypt the message for comparison to a confirm message generated there at line 466. The confirm message at the wireless peripheral device 452 is encrypted and sent to the information handling system at line 442 and decrypted at the information handling system 400 as well. Then the received confirm message decrypted at the information handling system is compared to the original confirm message generated there at line 444. With such encryption and decryption of the messages exchanged with the corresponding GOB temporary keys, if the confirm messages match, then the OOB temporary keys 466 match on the wireless peripheral device 452 and the information handling system 400. This may verify BT pairing in one example embodiment. In an embodiment, the automatic verification and initiation of the BT pairing process may use a Bluetooth out-of-band (OOB), a legacy BLE GOB pairing, a Bluetooth Low Energy (BLE) GOB pairing protocol, or any other suitable protocol to verify and then to BT pair the wireless peripheral device 452 to the information handling system 400. In an embodiment, the information handling system 400 and wireless peripheral device 452 can each provide various automatic querying, verification, and BT pairing communications that includes the OOB temporary key 466 verification and a pairing response command via an OOB BT communication. At line 448, the wireless peripheral device 452 and the information handling system 400 may then establish a BT wireless link with a session key under any BT protocol.

In a particular example embodiment, the information handling system 400 may encrypt an Mconfirm value from its copy of the OOB temporary key 466 via an encryption algorithm, provide encrypted Mconfirm to the wireless peripheral device 452 at line 442, for decryption at the wireless peripheral device 452 using its own stored copy of the OOB temporary key 466. Further, the decrypted Mconfirm value may be compared to an Sconfirm value generated at the wireless peripheral device 452 at line 446. The generated Sconfirm value may be encrypted at the wireless peripheral device 452 with its copy of the OOB temporary key 466 and sent to the information handling system 400 at line 442 as well. The information handling system may decrypt the Sconfirm value using its OOB temporary key 466 to determine the sent Sconfirm value at line 442 and compare it to the Mconfirm value at line 444. A match of the received Sconfirm from the wireless peripheral device 452 with the Mconfirm from the information handling system 400 at lines 444 and 446 may be used as verification of BT pairing in such an example embodiment. Where the values match, the BT pairing process establishes a session key and a BT wireless link via the OS BT stack and BT protocols at line 448. Then the BT pairing process is completed between the wireless peripheral device 452 and information handling system 400. In an embodiment, once the wireless peripheral device 452 is paired with the information handling system 400, the OOB temporary key 466 is no longer used and the OOB temporary key 466 on both the information handling system 400 and the wireless peripheral device 452 may be deleted at line 448. Thus, in an embodiment, the OOB temporary key 466 may be a single use temporary key in some embodiments.

The blocks of the flow diagrams of FIGS. 3 and 4 or steps and aspects of the operation of the embodiments herein and discussed above need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system comprising:
a hardware processor;
a memory device;
a power management unit (PMU) to provide power to the hardware processor and memory device;
the hardware processor executing computer readable program code of an automatic peripheral device pairing management system pairing agent to receive, via a wireless interface adapter, a symmetric key from a backend management server;
the hardware processor executing computer readable program code of the automatic peripheral device pairing management system to, via the wireless interface adapter, receive a symmetric key-wrapped secure pairing key data package from a wireless peripheral device as part of a pairing query; and
the hardware processor to, with the symmetric key, unwrap the symmetric key-wrapped secure pairing key data package to obtain pairing key data used to automatically Bluetooth® (BT) pair the backend coupled information handling system to the wireless peripheral device when the pairing key data matches peripheral device pairing key data at the wireless peripheral device.

2. The information handling system of claim 1 further comprising:
the hardware processor of the information handling system to execute the computer readable program code of the automatic peripheral device pairing management system pairing agent to unwrap the symmetrical key wrapped pairing key data package using the copy of the symmetric key to yield the pairing key data that includes an out-of-band (OOB) temporary key and a peripheral device identification (PD ID).

3. The information handling system of claim 1 further comprising:
the hardware processor of the backend coupled information handling system to execute the computer readable program code of the automatic peripheral device pairing management system pairing agent to unwrap the symmetrical key-wrapped pairing key data package using the copy of the symmetric key to yield the pairing key data that includes seed and index data and a peripheral device identification (PD ID); and
the hardware processor executing code instructions of a hash loop at the information handling system to calculate an out-of-band (OOB) temporary key for automatic verification and pairing with the wireless peripheral device.

4. The information handling system of claim 1 further comprising:
the hardware processor executing computer readable program code of the automatic peripheral device pairing management system pairing agent to automatically verify and pair with the wireless peripheral device by detecting a transmitted PD ID from the wireless peripheral device that matches a PD ID unwrapped from the symmetrical key-wrapped pairing key data package at the information handling system.

5. The information handling system of claim 1 further comprising:
the hardware processor executing computer readable program code of the automatic peripheral device pairing management system pairing agent to automatically verify and pair with the wireless peripheral device when a detected received signal strength indicator (RSSI) level from a wireless peripheral device meets or exceeds a RSSI threshold level.

6. The information handling system of claim 1 further comprising:
the symmetric key-wrapped secure pairing key data package having the pairing key data including an OOB temporary key, wherein the OOB temporary key is generated by execution of a key generating algorithm at the wireless peripheral device after the wireless peripheral device has been turned on and before the wireless peripheral device broadcasts the symmetrical key-wrapped secure pairing key data package.

7. The information handling system of claim 6, wherein the received symmetrical key-wrapped pairing key data package was key-wrapped via a hardware controller of the peripheral device executes computer readable program code of an out-of-band (OOB) temporary key encryption agent to encrypt the OOB temporary key and the PD ID with a copy of the symmetric key to create the symmetrical key-wrapped secure pairing key data package.

8. The information handling system of claim 1 further comprising:
the hardware processor executing computer readable program code of the automatic peripheral device pairing management system pairing agent to delete an OOB temporary key unwrapped derived from the symmetric key-wrapped secure pairing key data package after the backend-coupled information handling system has been BT paired with the wireless peripheral device.

9. An information handling system comprising:
a hardware processor;
a memory device;
a power management unit (PMU) to provide power to the hardware processor and memory device;
the hardware processor executing computer readable program code of an automatic peripheral device pairing management system pairing agent to receive, via a wireless interface adapter, a symmetric key from a wireless peripheral device manufacturer;
the hardware processor executing computer readable program code of the automatic peripheral device pairing management system to, via the wireless interface adapter, receive a symmetric key-wrapped secure pairing key data package from a wireless peripheral device; and
the hardware processor to, with the symmetric key, unwrap the symmetric key-wrapped secure pairing key data package to obtain pairing key data used to automatically verify and Bluetooth® BT pair the wireless peripheral device with the information handling system.

10. The information handling system of claim 9 further comprising:
the hardware processor of the information handling system to execute the computer readable program code of the automatic peripheral device pairing management system pairing agent to unwrap the symmetrical key wrapped pairing key data package using the copy of the symmetric key to obtain the pairing key data that includes an out-of-band (OOB) temporary key and peripheral device identification (PD ID) for access by an operating system (OS) BT stack for automatic verification and pairing with the wireless peripheral device.

11. The information handling system of claim 9 further comprising:
the hardware processor of the information handling system to execute the computer readable program code of the automatic peripheral device pairing management system pairing agent to unwrap the symmetrical key-wrapped pairing key data package using the copy of the symmetric key to obtain the pairing key data that includes seed and index data and a PD ID, where the seed and index data is used in a hash loop executed by a hardware processor of the information handling system to generate an OOB temporary key for access by an operating system (OS) Bluetooth® (BT) stack for automatic verification and pairing with the wireless peripheral device.

12. The information handling system of claim 9 further comprising:
the hardware processor executing computer readable program code of the automatic peripheral device pairing management system pairing agent to determine that a PD ID transmitted from the wireless peripheral device matches the PD ID derived from the symmetrical key-wrapped pairing key data package to initiate automatic BT pairing with the wireless peripheral device.

13. The information handling system of the claim 19 further comprising:
the hardware processor executing computer readable program code of the automatic peripheral device pairing management system pairing agent to automatically pair with the wireless peripheral device when a detected received signal strength (RSSI) level from a wireless peripheral device meets or exceeds a RSSI threshold level.

14. The information handling system of claim 9 further comprising:
the wireless interface adapter receiving the symmetric key-wrapped secure pairing key data package including an OOB temporary key, wherein the OOB temporary key is generated by the wireless peripheral device after the wireless peripheral device has been turned on and before the wireless peripheral device broadcasts the symmetrical key-wrapped pairing key data package.

15. The information handling system of claim 9 further comprising:
the hardware processor executing computer readable program code of the automatic peripheral device pairing management system pairing agent to delete OOB temporary key derived from the symmetric key-wrapped secure pairing key data package after the information handling system has been BT paired with the wireless peripheral device.

16. A wireless peripheral device comprising:
a peripheral device hardware controller;
a memory device;
a power source to provide power to the peripheral device hardware controller and memory device;
the peripheral device hardware controller executing computer readable program code of an automatic peripheral device pairing management agent to receive a symmetric key and a peripheral device identification (PD ID) and, with a random number generator and key generation algorithm, generate an out-of-band (OOB) temporary key using seed data and an index;
the peripheral device hardware controller executing computer readable program code of a OOB temporary key encryption agent to encrypt a symmetrical key wrapped pairing key data package including pairing key data;
the wireless interface adapter to, with a Bluetooth® (BT) radio, transmit the symmetrical key wrapped pairing key data package to an information handling system in preparation to BT pair with the information handling system;
the peripheral device hardware controller executing the computer readable program code of the automatic peripheral device pairing management agent to broadcast the PD ID to the information handling system in pairing query; and
the peripheral device hardware controller executing the computer readable program code of the automatic peripheral device pairing management agent to BT pair the wireless peripheral device with the information handling system by executing a confirm value generation function to determine that the OOB temporary key at the information handling system matches the OOB temporary key generated at the wireless peripheral device.

17. The wireless peripheral device of claim 16 further comprising:
the symmetrical key wrapped pairing key data package including a copy of the seed and index data encrypted and transmitted to the information handling system to generate an OOB temporary key at the information handling system.

18. The wireless peripheral device of claim 16 further comprising:
the symmetrical key wrapped pairing key data package including a copy of the OOB temporary key generated at the wireless peripheral device and the PD ID encrypted and transmitted to the information handling system.

19. The wireless peripheral device of claim 16 further comprising:
the memory device including a tamper-resistant storage location to prevent use of the OOB temporary key and PD ID prior to pairing the wireless peripheral device with the information handling system.

20. The wireless peripheral device of claim 16 further comprising:
the peripheral device hardware controller to execute the computer readable program code of the automatic peripheral device pairing management agent to send a received signal strength indicator (RSSI) level to the information handling system to determine verify that the wireless peripheral device is close enough to the information handling system to meet an RSSI threshold to complete the BT pairing.
